(19) United States
(12) Patent Application Publication
(10) Pub. No.: US 2026/0096944 A1
(43) Pub. Date: Apr. 9, 2026

(54) METHOD FOR CONTROLLING WEARABLE DEVICE TO OUTPUT VISUAL GUIDE AND ELECTRONIC DEVICE PERFORMING THE METHOD

(71) Applicant: Samsung Electronics Co., Ltd., Suwon-si (KR)

(72) Inventors: Kawon CHEON, Suwon-si (KR); Seungjoon LEE, Suwon-si (KR)

(21) Appl. No.: 19/348,552

(22) Filed: Oct. 2, 2025

Related U.S. Application Data
(63) Continuation of application No. PCT/KR2025/011811, filed on Aug. 6, 2025.

(30) Foreign Application Priority Data
Oct. 7, 2024 (KR) 10-2024-0135806

(51) Int. Cl. A61H 3/00; A61H 1/02

(52) U.S. Cl. CPC A61H 3/00; A61H 1/0244; A61H 2201/0188; A61H 2201/1215; A61H 2201/164; A61H 2201/5069; A61H 2201/5084

(57) ABSTRACT

A method, performed by an electronic device, for controlling a wearable device, may include acquiring sensor data generated by an angle sensor of the wearable device, generating gait information of a user wearing the wearable device based on the sensor data, determining whether a position of a first leg of the user corresponds to a target position based on the sensor data, and when the position of the first leg corresponds to the target position, controlling the wearable device so that a first visual guide associated with the first leg is output at a first position based on the gait information.

### CROSS-REFERENCE TO RELATED APPLICATIONS

This application is a continuation application of International Application No. PCT/KR2025/011811 designating the United States, filed on Aug. 6, 2025, in the Korean Intellectual Property Receiving Office and claiming priority to Korean Patent Application No. 10-2024-0135806, filed on Oct. 7, 2024, in the Korean Intellectual Property Office, the disclosures of which are incorporated by reference herein in their entireties.

### TECHNICAL FIELD

Certain example embodiments may relate to a method of controlling a wearable device to output a visual guide.

### BACKGROUND ART

Recently, various electronic devices for assisting walking and/or exercise have been proposed. These electronic devices may output assistive torque to facilitate the user's walking and/or output resistive torque for the user's muscle-strengthening exercise. Such electronic devices may sense information on the user's movement through various sensors. The information on the user's movement may be sensed, and the electronic device may be controlled based on the sensed information.

### SUMMARY

According to an example embodiment, an electronic device may include at least one processor including processing circuitry, and a memory including one or more storage media storing instructions, in which the instructions, when executed individually and/or collectively by the at least one processor, may cause the electronic device to acquire sensor data generated by an angle sensor of a wearable device.

According to an example embodiment, the instructions, when executed individually and/or collectively by the at least one processor, may cause the electronic device to generate gait information of a user wearing the wearable device based on the sensor data.

According to an example embodiment, the instructions, when executed individually and/or collectively by the at least one processor, may cause the electronic device to determine whether a position of a first leg of the user corresponds to a target position based on the sensor data.

According to an example embodiment, the instructions, when executed individually and/or collectively by the at least one processor, may cause the electronic device to, when the position of the first leg corresponds to the target position, control the wearable device so that a first visual guide associated with the first leg is output at a first position based on the gait information.

According to an example embodiment, a method, performed by an electronic device, for controlling a wearable device may include acquiring sensor data generated by an angle sensor of the wearable device.

According to an example embodiment, the method may include generating gait information of a user wearing the wearable device based on the sensor data.

According to an example embodiment, the method may include determining whether a position of a first leg of the user corresponds to a target position based on the sensor data.

According to an example embodiment, the method may include, when the position of the first leg corresponds to the target position, controlling the wearable device so that a first visual guide associated with the first leg is output at a first position based on the gait information.

According to an example embodiment, a computer-readable storage medium storing a computer program that, when executed by a processor(s) comprising processing circuitry, causes the processor to perform the method may be provided.

According to an example embodiment, a wearable device may include a base body positioned at a waist part of a user when the wearable device is worn on the user's body, a waist support frame and a leg support frame configured to support at least a portion of the user's body, a thigh fastener configured to fix the leg support frame to a thigh of the user, an inertial measurement unit (IMU) disposed inside the base body, a driving module generating torque applied to a leg of the user, in which the driving module is positioned between the waist support frame and the leg support frame, and the driving module may include a motor and/or a motor driver circuit, one or more optical output devices outputting a visual guide on the ground, at least one processor including processing circuitry, and a memory including one or more storage media storing instructions.

According to an example embodiment, a first optical output device among the one or more optical output devices may be disposed on the driving module to output a first visual guide in front of the user when the wearable device is worn on the user's body.

### BRIEF DESCRIPTION OF DRAWINGS

With regard to the description of the drawings, the same or similar reference numerals may be used to refer to the same or similar components.

FIG. 1 is a diagram illustrating an overview of a wearable device worn on a user's body, according to an example embodiment.

FIG. 2 is a diagram illustrating an exercise management system including a wearable device and an electronic device, according to an example embodiment.

FIG. 3 is a rear schematic view of the wearable device, according to an example embodiment.

FIG. 4 is a left side view of the wearable device, according to an example embodiment.

FIGS. 5A and 5B are diagrams each illustrating a configuration of a control system of the wearable device, according to an example embodiment.

FIG. 6 is a diagram illustrating an interaction between the wearable device and the electronic device, according to an example embodiment.

FIG. 7 is a diagram illustrating a configuration of the electronic device, according to an example embodiment.

FIG. 8A is a diagram illustrating a front schematic view and a side schematic view of the wearable device including one or more optical output devices, according to an example embodiment.

FIG. 8B is a diagram illustrating visual guides output by one or more optical output devices, according to an example embodiment.

FIG. 9 is a flowchart of a method of controlling the wearable device to output a visual guide, according to an example embodiment.

FIG. 10 illustrates a method of generating gait information based on sensor data generated during the user's walking, according to an example embodiment.

FIG. 11A illustrates a visual guide associated with a leg, according to an example embodiment.

FIG. 11B illustrates a method of adjusting a position of the output visual guide, according to an embodiment.

FIG. 11C illustrates a method of adjusting an orientation angle of a light output device to output a visual guide based on an arrangement position of the light output device, according to an example embodiment.

FIG. 12 illustrates visual guides output based on a progress stage of a gait cycle, according to an example embodiment.

FIG. 13 illustrates a plurality of visual guides output to correspond to a plurality of predicted landing positions of a leg, according to an example embodiment.

FIG. 14 illustrates a plurality of visual guides output to correspond to a predicted landing position and a target landing position of a leg, according to an example embodiment.

FIG. 15 illustrates a plurality of visual guides output to improve gait symmetry, according to an example embodiment.

FIG. 16 illustrates a numerical count output in association with a visual guide, according to an example embodiment.

FIG. 17A is a flowchart illustrating a method of determining a position of a visual guide based on a target walking path, according to an embodiment.

FIG. 17B illustrates visual guides output based on the target walking path, according to an example embodiment.

FIG. 18 illustrates a first visual guide output in a shape determined based on a current walking posture of a leg, and a second visual guide output in a shape determined based on a target walking posture, according to an example embodiment.

FIG. 19A is a flowchart illustrating a method of outputting sound based on a landing position of a leg, according to an example embodiment.

FIG. 19B illustrates a method of outputting sound based on a landing position of the leg, according to an example embodiment.

FIG. 20 is a flowchart illustrating a method of outputting a visual guide based on a user's gaze direction, according to an example embodiment.

FIG. 21 is a flowchart illustrating a method of outputting a visual guide when the user is not walking, according to an example embodiment.

FIG. 22 illustrates a visual guide output when the user is not walking, according to an example embodiment.

### DETAILED DESCRIPTION

Hereinafter, certain example embodiments of the present disclosure will be described in detail with reference to the drawings so that one of ordinary skill in the art may easily practice the present disclosure. However, the present disclosure may be implemented in many different forms and is not limited to the embodiments described herein. In the drawings and the related description, the same or similar reference numerals may be used to designate the same or similar elements. In addition, in the drawings and the related description, well-known functions or structures may not be described in detail for clarity and conciseness.

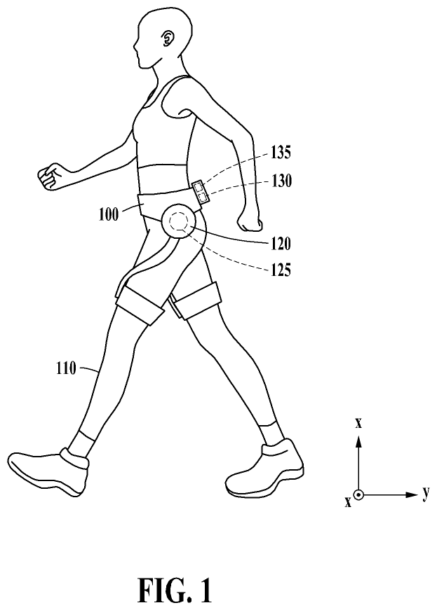

FIG. 1 is a diagram illustrating an overview of a wearable device worn on a body of a user, according to an embodiment.

Referring to FIG. 1, in an embodiment, a wearable device 100 may be a device worn on a body of a user 110 to assist the user 110 in walking, exercising, and/or working. In an embodiment, the wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device.” The user 110 may be a human or an animal, but examples are not limited thereto. The wearable device 100 may be worn on the body (e.g., a lower body (legs, ankles, or knees) or a waist) of the user 110 and apply an external force, such as an assistance force and/or a resistance force, to a body motion of the user 110. The assistance force may be a force assisting the body motion of the user 110, which is applied in the same direction as a direction of the body motion of the user 110. The resistance force May be a force impeding the body motion of the user 110, which is applied in an opposite direction to the direction of the body motion of the user 110. The term “resistance force” may also be referred to as “exercise load”.

In an embodiment, the wearable device 100 may operate in a walking assistance mode for assisting the user 110 in walking. In the walking assistance mode, the wearable device 100 may assist the walking of the user 110 by applying an assistance force generated through a driving module 120 of the wearable device 100 to the body of the user 110. The wearable device 100 may expand the walking ability of the user 110 by allowing the user 110 to walk independently or walk for a long time by providing a force needed for the walking of the user 110. The wearable device 100 may assist a walker in improving an abnormal walking habit or walking posture.

In an embodiment, the wearable device 100 may operate in an exercise assistance mode for enhancing the exercise effect of the user 110. In the exercise assistance mode, the wearable device 100 may impede a body motion of the user 110 or provide resistance to the body motion of the user 110 by applying a resistance force generated from the driving module 120 to the body of the user 110. When the wearable device 100 is a hip-type wearable device that is worn on a waist (or pelvis) and legs (e.g., thighs) of the user 110, the wearable device 100 may provide an exercise load to a leg motion of the user 110 while being worn on the legs, thereby enhancing the exercise effect on the legs of the user 110. In an embodiment, the wearable device 100 may apply an assistance force to the body of the user 110 to assist the user 110 in exercising. For example, when a person with a disability or an elderly person wants to exercise by wearing the wearable device 100, the wearable device 100 may provide an assistance force to assist a body motion during an exercise process. In an embodiment, the wearable device 100 may provide an assistance force and a resistance force in combination for each exercise section or time section, in such a manner of providing an assistance force in some exercise sections and a resistance force in other exercise sections.

In an embodiment, the wearable device 100 may operate in a physical ability measurement mode to measure a physical ability of the user 110. The wearable device 100 may measure motion information of the user 110 using sensors (e.g., an angle sensor 125 and an inertial measurement unit (IMU) 135) provided in the wearable device 100 while the user 110 is walking or exercising and may evaluate the physical ability of the user 110 based on the measured motion information. For example, a gait index or an exercise ability indicator (e.g., a muscular strength, endurance, balance, or exercise posture) of the user 110 may be estimated based on the motion information of the user 110 measured by the wearable device 100. The physical ability measurement mode may include an exercise posture measurement mode to measure an exercise motion of the user 110.

In embodiments of the present disclosure, for convenience of description, the wearable device 100 is described as an example of a hip-type wearable device, as illustrated in FIG. 1, but the embodiments are not limited thereto. As described above, the wearable device 100 may be worn on another body part (e.g., the upper arms, lower arms, hands, calves, or feet) other than the waist and legs (particularly, the thighs), and the shape and configuration of the wearable device 100 may vary depending on the body part on which the wearable device 100 is worn.

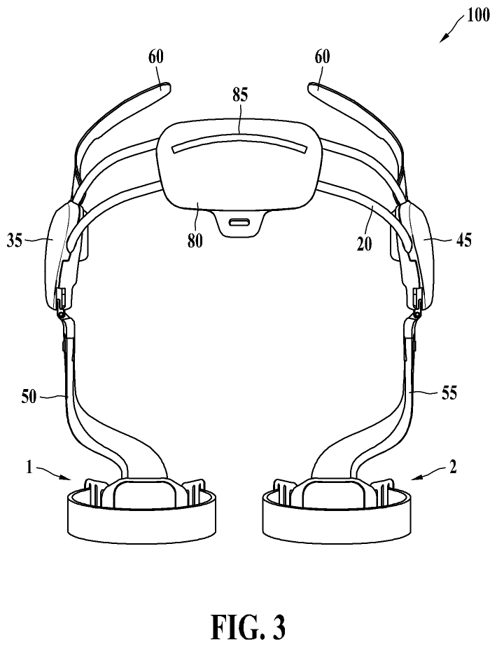

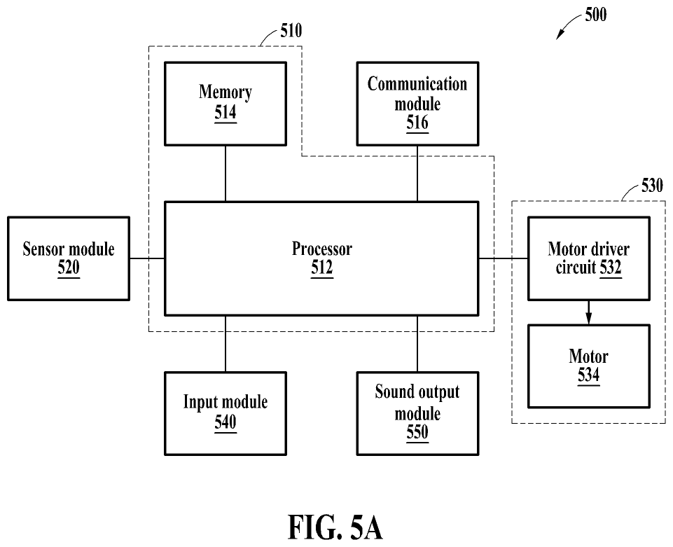

According to an embodiment, the wearable device 100 may include a support frame (e.g., leg support frames 50 and 55 and a waist support frame 20 of FIG. 3) configured to support the body of the user 110 when the wearable device 100 is worn on the body of the user 110, a sensor module (e.g., a sensor module 520 of FIG. 5A) configured to obtain sensor data including motion information regarding a body motion (e.g., a motion of a leg, and a motion of an upper body) of the user 110, the driving module 120 (e.g., driving modules 35 and 45 of FIG. 3) configured to generate torque to be applied to the legs of the user 110, and a control module 130 (e.g., a control module 510 of FIGS. 5A and 5B) configured to control the wearable device 100. Each driving module herein may comprise a motor and/or circuitry.

The sensor module may include the angle sensor 125 and the IMU 135. The angle sensor 125 may measure a rotation angle of a leg support frame of the wearable device 100 corresponding to a hip joint angle value of the user 110. The rotation angle of the leg support frame measured by the angle sensor 125 may be estimated as the hip joint angle value (or a leg angle value) of the user 110. The angle sensor 125 may include, for example, an encoder, a resolver, a home sensor, and/or a hall sensor. In an embodiment, the angle sensor 125 may be present near each of a right hip joint and a left hip joint of the user 110. The IMU 135 may include an acceleration sensor and/or an angular velocity sensor and measure a change in acceleration and/or angular velocity according to a motion of the user 110. The IMU 135 may measure, for example, an upper body motion value of the user 110 corresponding to a motion value of a waist support frame (or a base body (a base body 80 of FIG. 3)) of the wearable device 100. The motion value of the waist support frame measured by the IMU 135 may be estimated as the upper body motion value of the user 110.

In an embodiment, the control module 130 and the IMU 135 may be provided within the base body (e.g., the base body 80 of FIG. 3) of the wearable device 100. The base body may be on the waist (or a lumbar region) of the user 110 when the user 110 wears the wearable device 100. The base body may be formed on or attached to the outside of the waist support frame of the wearable device 100. The base body may be mounted on, directly or indirectly, the lumbar region of the user 110 to provide a cushioning feeling to the lower back of the user 110 and support the lower back of the user 110 together with the waist support frame. Each control module herein may comprise control and/or processing circuitry.

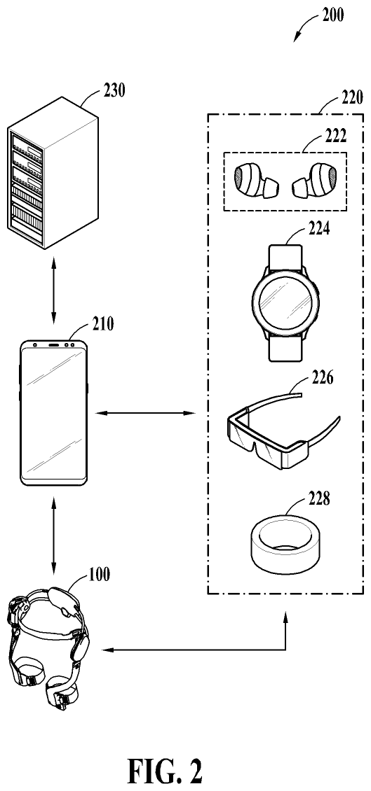

FIG. 2 is a diagram illustrating an exercise management system including a wearable device and an electronic device, according to an embodiment.

Referring to FIG. 2, an exercise management system 200 may include the wearable device 100 to be worn on a body of a user, an electronic device 210, another wearable device 220, and a server 230. In an embodiment, at least one (e.g., the other wearable device 220 or the server 230) of the above devices may be omitted from the exercise management system 200, or one or more other devices (e.g., a dedicated controller device of the wearable device 100) may be added thereto.

In an embodiment, the wearable device 100 may be worn on the body of the user in a walking assistance mode to assist a motion of the user. For example, the wearable device 100 may be worn on legs of the user to help the user in walking by generating an assistance force that assists a leg motion of the user.

In an embodiment, the wearable device 100 may generate a resistance force for impeding a body motion of the user or an assistance force for assisting a body motion of the user and apply the generated resistance force or assistance force to the body of the user to enhance the exercise effect of the user in an exercise assistance mode. In the exercise assistance mode, the user may select, through the electronic device 210, an exercise program (e.g., squat, split lunge, dumbbell squat, lunge and knee up, or stretching) to be performed using the wearable device 100, and/or an exercise intensity to be applied to the wearable device 100. The wearable device 100 may control a driving module of the wearable device 100 according to the exercise program selected by the user and obtain sensor data including the user's motion information from a sensor module. The wearable device 100 may adjust the intensity of a resistance force or an assistance force applied to the user according to the exercise intensity selected by the user. For example, the wearable device 100 may control the driving module to generate a resistance force corresponding to the exercise intensity selected by the user.

In an embodiment, the wearable device 100 may be used to measure a physical ability of the user by in conjunction with the electronic device 210. Under the control of the electronic device 210, the wearable device 100 may operate in a physical ability measurement mode, which is a mode for measuring the physical ability of the user and transmit sensor data obtained from the user's motion in the physical ability measurement mode to the electronic device 210. The electronic device 210 may estimate the physical ability of the user by analyzing the sensor data received from the wearable device 100.

The electronic device 210 may communicate with the wearable device 100 and remotely control the wearable device 100 or provide the user with state information regarding a state (e.g., a booting state, a charging state, a sensing state, or an error state) of the wearable device 100. The electronic device 210 may receive the sensor data obtained by a sensor in the wearable device 100 from the wearable device 100 and estimate the physical ability of the user or an exercise result based on the received sensor data. In an embodiment, when the user exercises while wearing the wearable device 100, the wearable device 100 may obtain sensor data including the user's motion information from sensors and transmit the obtained sensor data to the electronic device 210. The electronic device 210 may extract a motion value of the user from the sensor data and evaluate an exercise posture of the user based on the extracted motion value. The electronic device 210 may provide the user with an exercise posture measurement value and exercise posture evaluation information related to the user's exercise posture through a graphical user interface (GUI).

In an embodiment, the electronic device 210 may execute a program (e.g., an application) configured to control the wearable device 100, and the user may adjust an operation or a set value of the wearable device 100 (e.g., the magnitude of torque output from a driving module (e.g., driving modules 35 and 45 of FIG. 3), the volume of audio output from a sound output module (e.g., a sound output module 550 of FIGS. 5A and 5B), or the brightness of a lighting unit (e.g., a lighting unit 85 of FIG. 3)) through the corresponding program. The program executed by the electronic device 210 may provide a GUI for interaction with the user. The electronic device 210 may be a device in various forms. For example, the electronic device 210 may include a portable communication device (e.g., a smartphone), a computer device, an access point, a portable multimedia device, or a home appliance (e.g., a television, an audio device, or a projector device), but examples are not limited thereto.

According to an embodiment, the electronic device 210 may be connected to the server 230 via short-range wireless communication or cellular communication. The server 230 may receive user profile information of the user who uses the wearable device 100 from the electronic device 210 and store and manage the received user profile information. The user profile information may include, for example, at least one of name, age, gender, height, weight, and body mass index (BMI). The server 230 may receive exercise history information regarding an exercise performed by the user from the electronic device 210 and may store and manage the received exercise history information. The server 230 may provide the electronic device 210 with various exercise programs or physical ability measurement programs that may be provided to the user.

According to an embodiment, the wearable device 100 and/or the electronic device 210 may be connected, directly or indirectly, to the other wearable device 220. The other wearable devices 220 may include, for example, wireless earphones 222, a smartwatch 224, smart glasses 226, or a smart ring 228, but examples are not limited to the foregoing devices. In an embodiment, the smartwatch 224 may measure a biosignal including heart rate information of the user and transmit the measured biosignal to the electronic device 210 and/or the wearable device 100. The electronic device 210 may estimate the heart rate information (e.g., a current heart rate, a maximum heart rate, or an average heart rate) of the user, based on the biosignal received from the smartwatch 224, and provide the estimated heart rate information to the user. In an embodiment, the smart ring 228 may measure a biosignal including heart rate information of the user and transmit the measured biosignal to the electronic device 210 and/or the wearable device 100. The electronic device 210 may estimate the heart rate information (e.g., a current heart rate, a maximum heart rate, or an average heart rate) of the user, based on the biosignal received from the smart ring 228, and provide the estimated heart rate information to the user.

In an embodiment, the exercise result information, physical ability information, and/or exercise posture evaluation information evaluated by the electronic device 210 may be transmitted to the other wearable device 220 and provided to the user through the other wearable device 220. The state information of the wearable device 100 may also be transmitted to the other wearable device 220 and provided to the user through the other wearable device 220. In an embodiment, the wearable device 100, the electronic device 210, and the other wearable device 220 may be connected to one another via wireless communication (e.g., Bluetooth™ or Wi-Fi).

In an embodiment, the wearable device 100 may provide (or output) feedback (e.g., visual feedback, auditory feedback, or haptic feedback) corresponding to the state of the wearable device 100 according to a control signal received from the electronic device 210. For example, the wearable device 100 may provide visual feedback through the lighting unit (e.g., the lighting unit 85 of FIG. 3) and provide auditory feedback via the sound output module (e.g., the sound output module 550 of FIGS. 5A and 5B). The wearable device 100 may include a haptic module and provide haptic feedback as vibration to the user's body via the haptic module. The electronic device 210 may also provide (or output) feedback (e.g., visual feedback, auditory feedback, or haptic feedback) corresponding to the state of the wearable device 100.

In an embodiment, the electronic device 210 may present a personalized exercise goal to the user in the exercise assistance mode. The personalized exercise goal may include target amounts of exercise for each exercise type (e.g., strength exercise, balance exercise, or aerobic exercise) selected by the user and determined by the electronic device 210 and/or the server 230. When the server 230 determines a target amount of exercise, the server 230 may transmit information regarding the determined target amount of exercise to the electronic device 210. The electronic device 210 may personalize and present the target amounts of exercise for each exercise type, such as strength exercise, aerobic exercise, or balance exercise, based on a selected exercise program (e.g., squat, split lunge, or lunge and knee up) and/or the physical characteristics (e.g., age, height, weight, and BMI) of the user. The electronic device 210 may display, on a display, a GUI screen indicating the target amounts of exercise for each exercise type.

In an embodiment, the electronic device 210 and/or the server 230 may include a database in which information regarding a plurality of exercise programs to be provided to the user through the wearable device 100 is stored. To achieve the user's exercise goal, the electronic device 210 and/or the server 230 may recommend an exercise program suitable for the user. The exercise goal may include, for example, at least one of muscle strength improvement, physical strength improvement, cardiovascular endurance improvement, core stability improvement, flexibility improvement, or symmetry improvement. The electronic device 210 and/or the server 230 may store and manage an exercise program performed by the user, results of performing the exercise program, and other associated information.

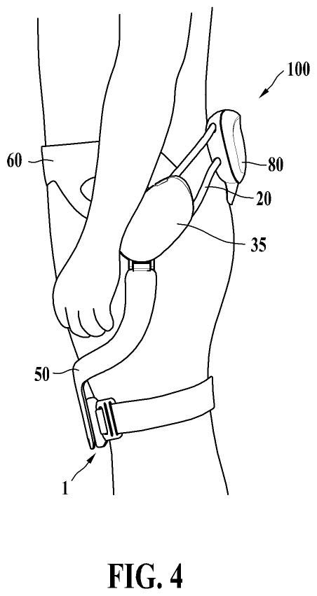

FIG. 3 is a rear schematic view of the wearable device according to an embodiment. FIG. 4 is a left side view of the wearable device according to an embodiment.

Referring to FIGS. 3 and 4, the wearable device 100, according to an embodiment, may include the base body 80, the waist support frame 20, the driving modules 35 and 45, the leg support frames 50 and 55, thigh fasteners 1 and 2, and the waist fastener 60. The base body 80 may include the lighting unit 85. In an embodiment, at least one (e.g., the lighting unit 85) of the above components may be omitted from the wearable device 100, or one or more other components (e.g., a haptic module) may be added to the wearable device 100.

The base body 80 may be on the waist of a user when the user wears the wearable device 100. The base body 80 worn on the waist of the user may cushion the waist of the user and support the waist of the user. The base body 80 may be above a hip of the user when the user wears the wearable device 100 so that the wearable device 100 may not slip downward due to gravity. The base body 80 may distribute a portion of the weight of the wearable device 100 to the user's waist when the user wears the wearable device 100. The base body 80 may be connected, directly or indirectly, to the waist support frame 20. Waist support frame connecting elements (not shown) to be connected, directly or indirectly, to the waist support frame 20 may be provided at both end portions of the base body 80.

In an embodiment, the lighting unit 85 may be provided outside of the base body 80. The lighting unit 85 may include a light source (e.g., a light-emitting diode (LED)). The lighting unit 85 may emit light under the control of a control module (not shown) (e.g., the control module 510 of FIGS. 5A and 5B). According to an embodiment, the control module may control the lighting unit 85 to provide (or output) visual feedback corresponding to the state of the wearable device 100 to the user via the lighting unit 85.

The waist support frame 20 may extend from both end portions of the base body 80. The waist of the user may be accommodated inside the waist support frame 20. The waist support frame 20 may include one or more rigid body beams. Each beam may have a curved shape with a preset curvature so that the beam may surround the user's waist. The waist fastener 60 may be connected, directly or indirectly, to an edge of the waist support frame 20. The driving modules 35 and 45 may be connected, directly or indirectly, to the waist support frame 20.

In an embodiment, the control module, an IMU (not shown) (e.g., the IMU 135 of FIG. 1 or an IMU 522 of FIG. 5B), a communication module (not shown) (e.g., a communication module 516 of FIGS. 5A and 5B), and a battery (not shown) may be provided inside the base body 80. The base body 80 may protect the control module, the IMU, the communication module, and the battery. The control module may generate a control signal to control the operation of the wearable device 100. The control module may include a control circuit including a processor configured to control actuators of the driving modules 35 and 45 and memory. The control module may further include a power supply module (not shown) to supply power from a battery to each of the components of the wearable device 100.

In an embodiment, the wearable device 100 may include a sensor module (not shown) (e.g., the sensor module 520 of FIG. 5A) configured to obtain sensor data from at least one sensor. The sensor module may obtain sensor data that changes in response to a motion of a user. In an embodiment, the sensor module may obtain sensor data including motion information of the user and/or motion information of the components of the wearable device 100. The sensor module may include, for example, an IMU (e.g., the IMU 135 of FIG. 1 or the IMU 522 of FIG. 5B) configured to measure an upper body motion value of the user or a motion value of the waist support frame 20, and an angle sensor (e.g., the angle sensor 125 of FIG. 1 or a first angle sensor 524 and a second angle sensor 524-1 of FIG. 5B) configured to measure a hip joint angle value of the user or a motion value of the leg support frames 50 and 55, but is not limited thereto. For example, the sensor module may further include at least one of a position sensor, a temperature sensor, a biosignal sensor, or a proximity sensor.

The waist fastener 60 may be connected, directly or indirectly, to the waist support frame 20 and may attached (e.g., fix), directly or indirectly, the waist support frame 20 to the waist of the user. The waist fastener 60 may include, for example, a pair of belts.

The driving modules 35 and 45 may generate an external force (or torque) to be applied to the body of the user based on the control signal generated by the control module. For example, the driving modules 35 and 45 may generate an assistance force or resistance force to be applied to the legs of the user. In an embodiment, the driving modules 35 and 45 may include the first driving module 45 provided at a position corresponding to a position of a right hip joint of the user, and the second driving module 35 provided at a position corresponding to a position of a left hip joint of the user. The first driving module 45 may include a first actuator and a first joint member, and the second driving module 35 may include a second actuator and a second joint member. The first actuator may provide power to be transmitted to the first joint member, and the second actuator may provide power to be transmitted to the second joint member. The first actuator and the second actuator may each include a motor configured to generate power (or torque) by receiving power from the battery. When the motor is driven as the power is supplied thereto, the motor may generate a force (an assistance force) for assisting a body motion of the user or a force (a resistance force) for impeding a body motion of the user. In an embodiment, the control module may adjust the strength and direction of the force generated by the motor by adjusting the voltage and/or current supplied to the motor.

In an embodiment, the first joint member and the second joint member may receive power from the first actuator and the second actuator, respectively, and may apply an external force to the body of the user based on the received power. The first joint member and the second joint member may be provided at positions corresponding to joint portions of the user, respectively. One side of the first joint member may be connected, directly or indirectly, to the first actuator, and the other side of the first joint member may be connected, directly or indirectly, to the first leg support frame 55. The first joint member may be driven to rotate by power supplied from the first actuator. An encoder, a resolver, a home sensor, or a hall sensor configured to operate as an angle sensor for measuring a rotation angle of the first joint member (corresponding to a joint angle of the user) may be provided on one side of the first joint member. One side of the second joint member may be connected, directly or indirectly, to the second actuator, and the other side of the second joint member may be connected, directly or indirectly, to a second leg support frame 50. The second joint member may be driven to rotate by power supplied from the second actuator. An encoder, a resolver, a home sensor, or a hall sensor configured to operate as an angle sensor for measuring a rotation angle of the second joint member may also be provided on one side of the second joint member.

In an embodiment, the first actuator may be provided in a lateral direction of the first joint member, and the second actuator may be provided in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, embodiments are not limited thereto, and an actuator and a joint member may share a rotation axis. In an embodiment, each actuator may be spaced apart from a joint member. In this case, the driving module 35, 45 may further include a power transmission module (not shown) configured to transmit power from the actuator to the joint member. The power transmission module may be a rotary body, such as a gear, or a longitudinal member, such as a wire, a cable, a string, a spring, a belt, or a chain. However, the scope of the embodiment is not limited by a positional relationship between an actuator and a joint member and a power transmission structure described above.

In an embodiment, the leg support frame 50, 55 may support a leg (e.g., a thigh) of the user when the wearable device 100 is worn on the leg of the user. For example, the leg support frame 50, 55 may transmit power (torque) generated by the driving module 35, 45 to the thigh of the user, and the power may function as an external force to be applied to a motion of the leg of the user. Each of the leg support frames 50 and 55 may have one end portion connected, directly or indirectly, to a joint member so as to be rotatable, and the other end portion connected, directly or indirectly, to the thigh fasteners 1 and 2. Accordingly, the leg support frames 50 and 55 may transmit the power generated by the driving modules 35 and 45 to the thighs of the user while supporting the thighs of the user. For example, the leg support frames 50 and 55 may push or pull the thighs of the user. The leg support frames 50 and 55 may extend in a longitudinal direction of the thighs of the user. The leg support frames 50 and 55 may be bent to surround at least a portion of the circumference of the thighs of the user. The leg support frames 50 and 55 may include the first leg support frame 55 to support the right leg of the user, and the second leg support frame 50 to support the left leg of the user.

The thigh fasteners 1 and 2 may be connected, directly or indirectly, to the leg support frames 50 and 55 and may fix the leg support frames 50 and 55 to the thighs. The thigh fasteners 2 and 1 may include the first thigh fastener 2 configured to fasten the first leg support frame 55 to the user's right thigh, and the second thigh fastener 1 configured to fasten the second leg support frame 50 to the user's left thigh. In an embodiment, the first thigh fastener 2 may include a first cover, a first fastening frame, and a first strap, and the second thigh fastener 1 may include a second cover, a second fastening frame, and a second strap. The first cover and the second cover may apply torque generated by the driving modules 35 and 45 to the thighs of the user. The first cover and the second cover may be disposed on one side of each of the user's thighs so as to push or pull the user's thighs. The first cover and the second cover may be disposed on the front surfaces of the user's thighs. The first cover and the second cover may be disposed in the circumferential direction around the user's thighs. The first cover and the second cover may extend in opposite directions from the respective other end portions of the leg support frames 50 and 55 and include curved surfaces corresponding to the thighs of the user. Each of the first cover and the second cover may have one end portion connected to a fastening frame and the other end portion connected to a strap.

The first fastening frame and the second fastening frame may be provided, for example, to surround at least some portions of the circumferences of the thighs of the user and prevent or reduce chances of the thighs of the user from being separated from the leg support frames 50 and 55. The first fastening frame may have a fastening structure that connects the first cover to the first strap and the second fastening frame may have a fastening structure that connects the second cover to the second strap.

The first strap may surround a remaining portion of the circumference of the user's right thigh that is not covered by the first cover and the first fastening frame, and the second strap may surround a remaining portion of the circumference of the user's left thigh that is not covered by the second cover and the second fastening frame. The first strap and the second strap may include, for example, an elastic material (e.g., a band).

FIGS. 5A and 5B are diagrams, each illustrating a configuration of a control system of the wearable device according to an embodiment.

Referring to FIG. 5A, the wearable device 100 may be controlled by a control system 500. The control system 500 may include a control module 510, a communication module 516, a sensor module 520, a driving module 530, an input module 540, and a sound output module 550. In an embodiment, at least one (e.g., the sound output module 550) of the above components may be omitted from the control system 500, or one or more other components (e.g., a haptic module) may be added to the control system 500.

The driving module 530 may include a motor 534 to generate power (e.g., torque) and a motor driver circuit 532 to drive the motor 534. Although FIG. 5A illustrates the driving module 530 including one motor driver circuit 532 and one motor 534, this is merely an example. Referring to FIG. 5B, a control system 500-1 may include a plurality of (e.g., two or more) motor driver circuits 532 and 532-1 and a plurality of (e.g., two or more) motors 534 and 534-1. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also apply respectively to the motor driver circuit 532-1 and the motor 534-1 illustrated in FIG. 5B.

Referring back to FIG. 5A, the sensor module 520 may include a sensor circuit including at least one sensor. The sensor module 520 may obtain sensor data including motion information of a user or motion information of the wearable device 100. The sensor module 520 may transmit the obtained sensor data to the control module 510. The sensor module 520 may include an IMU 522 and an angle sensor (e.g., the first angle sensor 524 or the second angle sensor 524-1) as illustrated in FIG. 5B. The IMU 522 may measure an upper body motion value of the user. For example, the IMU 522 may measure accelerations and angular velocities along the X-, Y-, and Z-axes in response to a motion of the user. The IMU 522 may be used to measure, for example, at least one of a forward and backward tilt, a left and right tilt, or a rotation of the body of the user. In addition, the IMU 522 may obtain motion values (e.g., acceleration values and angular velocity values) of a waist support frame (e.g., the waist support frame 20 of FIG. 3) of the wearable device 100. The motion values of the waist support frame may correspond to upper body motion values of the user.

The angle sensor may measure a hip joint angle value based on a leg motion of the user. Sensor data that may be measured by the angle sensor may include, for example, a hip joint angle value of a right leg, a hip joint angle value of a left leg, and information regarding a direction of a motion of a leg. For example, the first angle sensor 524 of FIG. 5B may obtain the hip joint angle value of the right leg of the user, and the second angle sensor 524-1 may obtain the hip joint angle value of the left leg of the user. Each of the first angle sensor 524 and the second angle sensor 524-1 may include, for example, an encoder, a resolver, a home sensor, and/or a hall sensor. In addition, the angle sensors may obtain motion values of the leg support frames of the wearable device 100. For example, the first angle sensor 524 may obtain a motion value of the first leg support frame 55, and the second angle sensor 524-1 may obtain a motion value of the second leg support frame 50. The motion values of the leg support frames 50 and 55 may correspond to the hip joint angle values.

In an embodiment, the sensor module 520 may further include at least one of a position sensor configured to obtain a position value of the wearable device 100, a proximity sensor configured to sense the proximity of an object, a biosignal sensor configured to detect a biosignal of the user, or a temperature sensor configured to measure an ambient temperature.

The input module 540 may receive a command or data to be used by another component (e.g., the processor 512) of the wearable device 100 from the outside (e.g., a user) of the wearable device 100. The input module 540 may include an input component circuit. The input module 540 may include, for example, a key (e.g., a button) or a touch screen.

The sound output module 550 may output a sound signal to the outside of the wearable device 100. The sound output module 550 may provide auditory feedback to the user. For example, the sound output module 550 may include a speaker configured to play back a guiding sound signal (e.g., an operation start sound, an operation error alarm, or an exercise start alarm), music content, or a guiding voice for audibly informing predetermined information (e.g., exercise result information or exercise posture evaluation information).

In an embodiment, the control system 500 may further include a battery (not shown) configured to supply power to each component of the wearable device 100. The wearable device 100 may convert the power of the battery into power suitable for an operating voltage of each component of the wearable device 100 and supply the converted power to each component.

The driving module 530 may generate an external force to be applied to a leg of the user under the control of the control module 510. The driving module 530 may generate torque to be applied to the legs of the user based on a control signal generated by the control module 510. The control module 510 may transmit the control signal to the motor driver circuit 532. The motor driver circuit 532 may control the operation of the motor 534 by generating a current signal (or a voltage signal) corresponding to the control signal and supplying the generated current signal to the motor 534. In some cases, the current signal may not be supplied to the motor 534. Upon receiving a current signal and being driven, the motor 534 may generate torque to provide either an assistance force for assisting the user's leg motion or a resistance force for impeding the user's leg motion.

The control module 510 may control the overall operation of the wearable device 100 and generate control signals for controlling each component (e.g., the communication module 516 or the driving module 530). The control module 510 may include the processor 512 and memory 514.

The processor 512 may execute, for example, software to control at least one other component (e.g., a hardware or software component) of the wearable device 100 connected, directly or indirectly, to the processor 512 and perform various data processing and computation tasks. The software may include an application for providing a GUI. According to an embodiment, as at least a part of data processing or computation, the processor 512 may store instructions or data received from another component (e.g., the communication module 516) in the memory 514, may process the instructions or the data stored in the memory 514, and may store result data in the memory 514. According to an embodiment, the processor 512 may include a main processor (e.g., a central processing unit (CPU) or an application processor (AP)), or an auxiliary processor (e.g., a graphics processing unit (GPU), a neural processing unit (NPU), an image signal processor (ISP), a sensor hub processor, or a communication processor (CP)) that is operable independently of or in conjunction with the main processor. The auxiliary processor may be implemented separately from the main processor or as a part of the main processor.

The memory 514 may store various pieces of data used by at least one component (e.g., the processor 512) of the control module 510. The various pieces of data may include, for example, software, sensor data, input data, or output data for instructions related thereto. The memory 514 may include a volatile memory or a non-volatile memory (e.g., random-access memory (RAM), dynamic RAM (DRAM), or static RAM (SRAM)).

The communication module 516, comprising communication circuitry, may support establishing a direct (e.g., wired) communication channel or a wireless communication channel between the control module 510 and another component of the wearable device 100 or an external electronic device (e.g., the electronic device 210 or the other wearable device 220 of FIG. 2) and performing communication via the established communication channel. The communication module 516 may include a communication circuit configured to perform a communication function. For example, the communication module 516 may receive a control signal from an electronic device (e.g., the electronic device 210) and transmit the sensor data obtained by the sensor module 520 to the electronic device. According to an embodiment, the communication module 516 may include one or more CPs (not shown) that are operable independently of the processor 512 and that support direct (e.g., wired) communication or wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of the above communication modules may communicate with another component of the wearable device 100 and/or an external electronic device via a short-range communication network, such as Bluetooth™, Wi-Fi, or infrared data association (IrDA), or a long-range communication network, such as a legacy cellular network, a 5G network, a next-generation communication network, the Internet, or a computer network (e.g., a local area network (LAN) or a wide region network (WAN)).

In an embodiment, the control system 500, 500-1 may further include a haptic module (not shown). The haptic module may provide haptic feedback to the user under the control of the processor 512. The haptic module may convert an electrical signal into a mechanical stimulus (e.g., vibration or movement) or an electrical stimulus which may be recognized by a user via their tactile sensation or kinesthetic sensation. The haptic module may include a motor, a piezoelectric element, or an electrical stimulation device. In an embodiment, the haptic module may be positioned in at least one of the base body (e.g., the base body 80), the first thigh fastener 2, or the second thigh fastener 1.

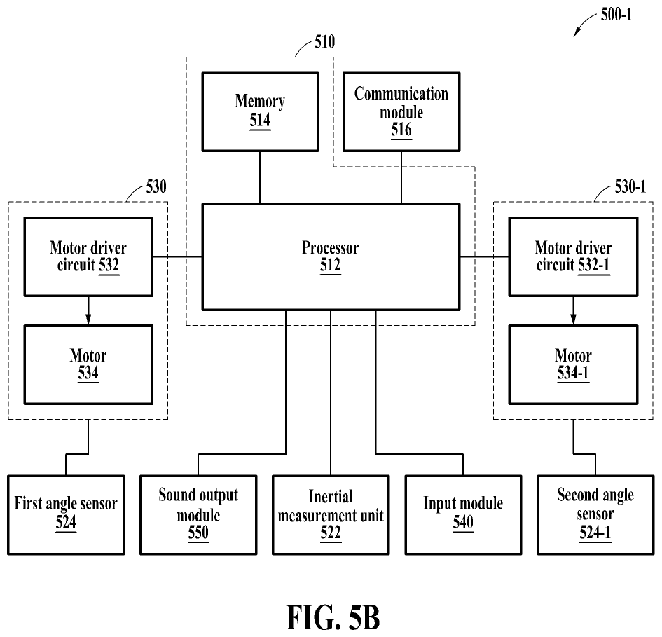

FIG. 6 is a diagram illustrating an interaction between a wearable device and an electronic device, according to an embodiment.

Referring to FIG. 6, the wearable device 100 may communicate with the electronic device 210. For example, the electronic device 210 may be a user terminal of a user using the wearable device 100 or a controller device dedicated to the wearable device 100. In an embodiment, the wearable device 100 and the electronic device 210 may be connected to each other through short-range wireless communication (e.g., Bluetooth™ or Wi-Fi communication).

In an embodiment, the electronic device 210 may check the state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a GUI.

In an embodiment, the user may input an instruction (e.g., an instruction to execute a walking assistance mode, an exercise assistance mode, or a physical ability measurement mode) to control the operation of the wearable device 100 or to change settings of the wearable device 100 through a GUI screen on the display 212 of the electronic device 210. The electronic device 210 may generate a control command (or a control signal) corresponding to an operation control command or a setting change instruction input by the user and transmit the generated control command to the wearable device 100. The wearable device 100 may operate based on the received control command and transmit, to the electronic device 210, a control result based thereon and/or sensor data from a sensor module of the wearable device 100. The electronic device 210 may provide the user with result information (e.g., gait ability information, exercise ability information, or exercise motion evaluation information) derived by analyzing the control result and/or the sensor data through the GUI screen.

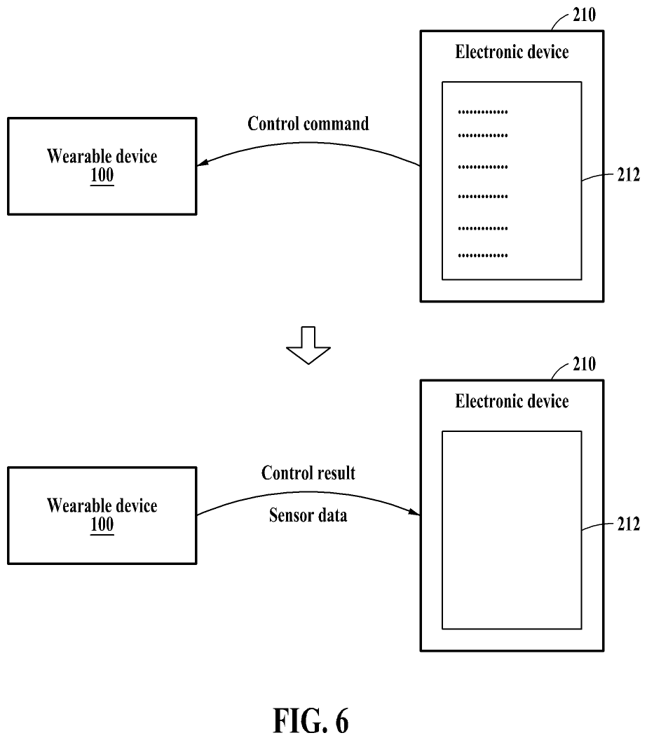

FIG. 7 is a diagram illustrating a configuration of an electronic device, according to an embodiment.

Referring to FIG. 7, the electronic device 210 may include a processor 710, memory 720, a communication module 730 comprising communication circuitry, a display module 740, a sound output module 750, and an input module 760. In an embodiment, at least one (e.g., the sound output module 750) of the above components may be omitted from the electronic device 210, or one or more other components (e.g., a sensor module and a battery) may be added to the electronic device 210.

The processor 710 may control at least one other component (e.g., a hardware or software component) of the electronic device 210 and perform various data processing and computation tasks. According to an embodiment, as at least a part of data processing or computation, the processor 710 may store instructions or data received from another component (e.g., the communication module 730) in the memory 720, process the instructions or data stored in the memory 720, and store result data in the memory 720.

In an embodiment, the processor 710 may include a main processor (e.g., a CPU or an AP) or an auxiliary processor (e.g., a GPU, an NPU, an ISP, a sensor hub processor, or a CP) that is operable independently of or in conjunction with the main processor.

The memory 720 may store various pieces of data used by at least one component (e.g., the processor 710 or the communication module 730) of the electronic device 210. The various pieces of data may include, for example, a program (e.g., an application) and input data or output data for a command related thereto. The memory 720 may include at least one instruction executable by the processor 710. The memory 720 may include volatile memory or non-volatile memory.

The communication module 730, comprising communication circuitry, may support establishing a direct (e.g., wired) communication channel or a wireless communication channel between the electronic device 210 and another electronic device (e.g., the wearable device 100, the other wearable devices 220, and the server 230) and performing communication via the established communication channel. The communication module 730 may include a communication circuit for performing a communication function. The communication module 730 may include one or more CPs that are operable independently of the processor 710 (e.g., an AP) and that support direct (e.g., wired) communication or wireless communication. According to an embodiment, the communication module 290 may include a wireless communication module configured to perform wireless communication (e.g., a Bluetooth communication module, a cellular communication module, a Wi-Fi communication module, or a GNSS communication module) or a wired communication module (e.g., a LAN communication module or a power line communication (PLC) module). For example, the communication module 730 may transmit a control command to the wearable device 100 and receive, from the wearable device 100, at least one of sensor data including body motion information of the user who is wearing the wearable device 100, state data of the wearable device 100, or control result data corresponding to the control command.

The display module 740 may visually provide information to the outside (e.g., the user) of the electronic device 210. The display module 740 may include, for example, a liquid-crystal display (LCD) or organic light-emitting diode (OLED) display, a hologram device, or a projector device. The display module 740 may further include a control circuit configured to control the driving of a display. In an embodiment, the display module 740 may include a touch sensor adapted to sense a touch, or a pressure sensor adapted to measure an intensity of a force incurred by the touch.

The sound output module 750 may output a sound signal to the outside of the electronic device 210. The sound output module 750 may include a guide sound signal (e.g., a driving start sound or an operation error notification sound) based on the state of the wearable device 100 and a speaker for playing musical content or a guide voice. When it is determined that the wearable device 100 is not properly worn on the body of the user, the sound output module 750 may output a guide voice to inform the user that they are wearing the wearable device 100 abnormally or to guide the user to wear the wearable device 100 normally. The sound output module 750 may output, for example, a guide voice corresponding to exercise evaluation information or exercise result information obtained by evaluating an exercise of the user.

The input module 760 may receive a command or data to be used by another component (e.g., the processor 710) of the electronic device 210 from the outside (e.g., the user) of the electronic device 210. The input module 760 may include an input component circuit and receive a user input. The input module 760 may include, for example, a key (e.g., a button) or a touch screen.

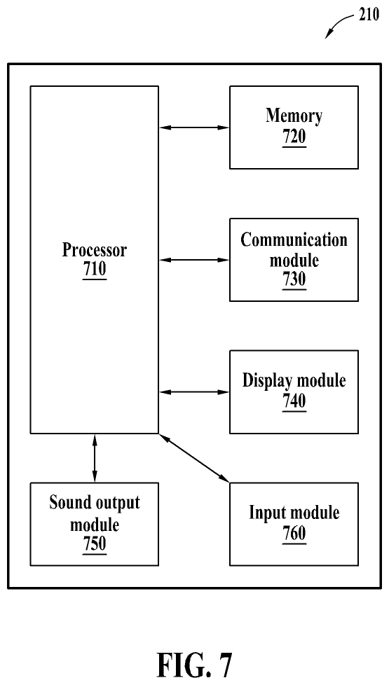

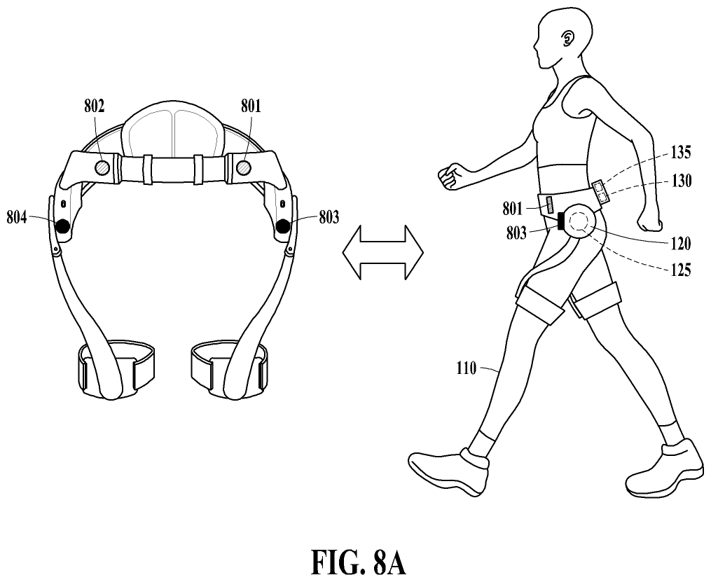

FIG. 8A is a diagram illustrating a front schematic view and a side schematic view of a wearable device including one or more optical output devices, according to an embodiment.

According to an embodiment, the wearable device 100 may include one or more optical output devices 801, 802, 803, and 804. Each of the one or more optical output devices 801, 802, 803, and 804 may be disposed on the wearable device 100 to output a visual guide onto the ground in front of the user 110 wearing the wearable device 100. Each of the one or more optical output devices 801, 802, 803, and 804 may be one or more of a laser beam projector, any other type of projector, any device comprising a light source such as a laser, LED, bulb, or the like, and/or may be an LED device, or may be any other suitable device that can provide an optical output, but this disclosure is so not limited. Each of the one or more optical output devices 801, 802, 803, and 804 may include a balancing device, such as a gimbal. Each of the one or more optical output devices 801, 802, 803, and 804 may include an orientation angle adjustment device capable of adjusting a position on the ground at which a visual guide is projected. For example, the orientation angle adjustment device may adjust a pitch angle and a yaw angle of a lens of a light output device.

According to an embodiment, the first optical output device 801 and the second optical output device 802 may be disposed on the waist fastener 60 of the wearable device 100. According to an embodiment, the third optical output device 803 and the fourth optical output device 804 may be disposed on the driving module 120 of the wearable device 100. The first optical output device 801 and the third optical output device 803 may be associated with movement of the user's left leg. The second optical output device 802 and the fourth optical output device 804 may be associated with movement of the user's right leg.

FIG. 8B is a diagram illustrating visual guides output by one or more optical output devices, according to an embodiment.

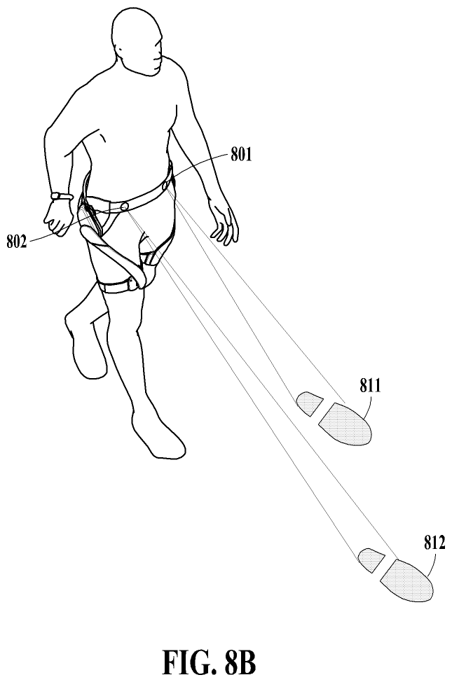

According to an embodiment, the user 110 may walk while wearing the wearable device 100. The wearable device 100 may output visual guides 811 and 812 associated with the user's walking. For example, the first optical output device 801 may output the first visual guide 811 associated with walking of the user's left leg, and the second optical output device 802 may output the second visual guide 812 associated with walking of the user's right leg. A position at which the first visual guide 811 is output may correspond to the next step position of the left leg, and a position at which the second visual guide 812 is output may correspond to the next step position of the right leg. The user 110 may recognize their walking path, moving direction, and walking speed through the first visual guide 811 and the second visual guide 812. Hereinafter, a method of controlling the wearable device 100 to output visual guides is described in detail below with reference to FIGS. 9 to 22.

FIG. 9 is a flowchart of a method of controlling a wearable device to output a visual guide, according to an embodiment.

In the following embodiments, operations may be performed sequentially but may not be necessarily performed sequentially. For example, the order of the operations may be changed and at least two of the operations may be performed in parallel.

Operations 910 to 980 described below may be performed by an electronic device (e.g., the wearable device 100 of FIG. 1 or the electronic device 210 of FIG. 2). The electronic device may include at least one processor (e.g., the processor 512 of FIG. 5A or the processor 710 of FIG. 7) and memory (e.g., the memory 514 of FIG. 5 or the memory 720 of FIG. 7) storing instructions. For example, the electronic device may be a user terminal physically separated from the wearable device 100. For example, the electronic device may be a control module (e.g., the control module 130 of FIG. 1 or the control module 510 of FIGS. 5A and 5B) included in the wearable device 100.

According to an embodiment, when the electronic device is a user terminal, a wireless connection may be established between the electronic device and the wearable device 100 when the wearable device 100 is powered on.

According to an embodiment, before operation 910 is performed, the electronic device may initialize values of one or more sensors of the wearable device 100. To initialize the values of one or more sensors, the electronic device may determine a calibration value for the values of one or more sensors. For example, the electronic device may instruct a user wearing the wearable device 100 to assume a reference posture and set a value obtained in the reference posture as a calibration value for the corresponding sensor. For example, the reference posture may include standing on a flat surface with both legs close together. For example, the reference posture may include performing a knee-up posture in place. For example, the reference posture may include performing a test walk of less than 10 meters. The electronic device may use calibration values to set the zero points of one or more sensors. For example, when the sensor measures 3 degrees in a state where 0 degrees should theoretically be measured, the value of 3 degrees may be determined as a calibration value.

According to an embodiment, when an optical output device may include a gravity sensor or an IMU, the electronic device may determine a calibration value used to control the posture of the optical output device by using a value of the gravity sensor or the IMU measured in the reference posture. The electronic device may control the optical output device to have a horizontal posture in the reference posture based on the calibration value.

In operation 910, the electronic device may obtain sensor data generated by an angle sensor (e.g., the angle sensor 125 of FIG. 1 or the first angle sensor 524 or the second angle sensor 524-1 of FIG. 5B) of the wearable device 100. For example, the angle sensor may include the first angle sensor 524 and the second angle sensor 524-1. The wearable device 100 may periodically transmit the sensor data generated by the angle sensor to the electronic device.

According to an embodiment, the electronic device may further obtain at least one of acceleration data and angular velocity data generated by an IMU (e.g., the IMU 135 of FIG. 1 or the IMU 522 of FIG. 5B) of the wearable device 100.

In operation 920, the electronic device may determine whether the user wearing the wearable device 100 is walking based on the sensor data. For example, the electronic device may determine whether the user is walking based on at least one of a change in angles sensed by the first angle sensor 524 or a change in angles sensed by the second angle sensor 524-1. When the user is standing still rather than walking, the angles sensed by the first angle sensor 524 or the second angle sensor 524-1 may not change.

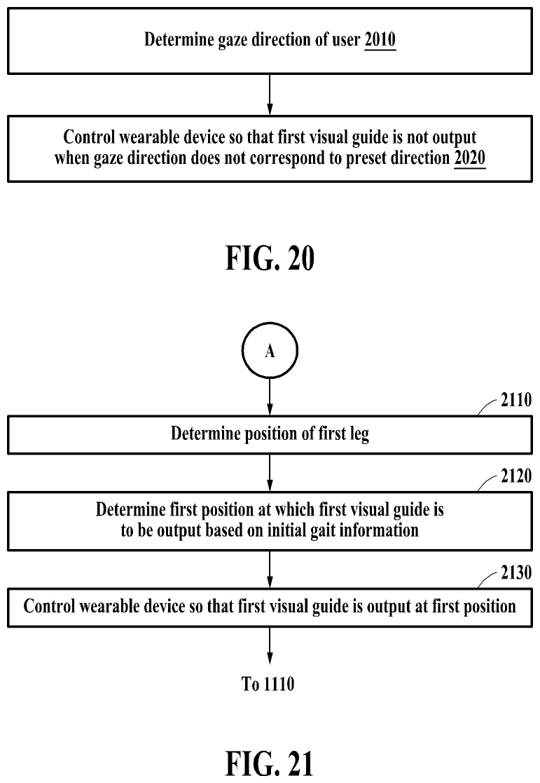

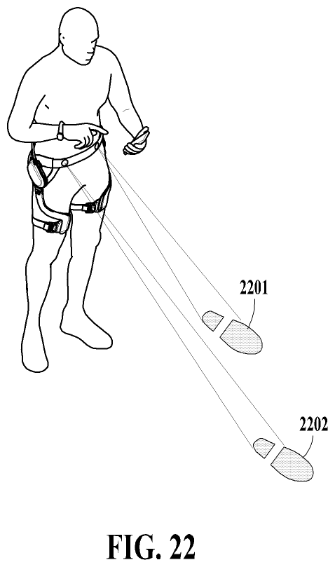

If the user is determined to be walking, operation 930 may then be performed. If the user is determined not to be walking, operation A may be performed. Operation A is described in detail below with reference to FIGS. 21 and 22.

In operation 930, the electronic device may generate gait information of the user wearing the wearable device 100 based on the sensor data. For example, the gait information may include at least one of the user's step length and walking speed. The step length may be an average step length. The walking speed may be an average walking speed.

According to an embodiment, the electronic device may determine the user's walking speed by employing a walking speed estimation model that receives sensor data as input. The electronic device may estimate the user's walking speed in real time using the walking speed estimation model.

According to an embodiment, acceleration data (e.g., acceleration along the x-, y-, and z-axes) and angular velocity (rotational velocity) data (e.g., angular velocity along the x-, y-, and z-axes) obtained by the IMU of the wearable device 100 may be input to the walking speed estimation model. The walking speed estimation model may output a walking speed estimation value based on the input acceleration and angular velocity data. According to an embodiment, hip-joint angular velocity data (e.g., angular velocity data corresponding to a right hip joint and angular velocity data corresponding to a left hip joint) obtained by the angle sensor of the wearable device 100, along with the acceleration data and angular velocity (rotation velocity) data obtained by the IMU of the wearable device 100 may be input to the walking speed estimation model. The walking speed estimation model may output the walking speed estimation value based on the input acceleration data and angular velocity data of the IMU and the input angular velocity data of the angle sensor. According to an embodiment, rotational angle data (e.g., a joint angle of the right hip joint and a joint angle of the left hip joint) and the hip-joint angular velocity data obtained by the angle sensor of the wearable device 100, along with the acceleration data and angular velocity (rotation velocity) data obtained by the IMU of the wearable device 100 may be input to the walking speed estimation model. The walking speed estimation model may output the walking speed estimation value based on the input acceleration data and angular velocity data of the IMU and the input rotational angle data and angular velocity data of the angle sensor. According to an embodiment, the rotational angle data (e.g., the joint angle of the right hip joint and the joint angle of the left hip joint) and the hip-joint angular velocity data obtained by the angle sensor of the wearable device 100 may be input to the walking speed estimation model, and the walking speed estimation model may output the walking speed estimation value based on the input rotational angle data and angular velocity data of the angle sensor.

The walking speed estimation model may be trained to output a walking speed estimation value corresponding to input sensor data based on input sensor data (e.g., the sensor data obtained by the IMU and/or the sensor data obtained by the angle sensor). For example, the walking speed estimation model may be trained using machine learning or linear regression, based on training data (e.g., sensor data measured during walking and an actual walking speed value corresponding to the sensor data). In an embodiment, the walking speed estimation model may be, for example, a convolutional neural network (CNN), a recurrent neural network (RNN), a gated recurrent unit (GRU), a ResNet, a long, short-term memory (LSTM), or a linear regression model, or any combination (e.g., a combination of a CNN and an LSTM) of two or more thereof. The walking speed estimation model may be trained based on a supervised learning method of machine learning. In a training process, an error backpropagation algorithm or a gradient descent algorithm may be used. For example, during training, the process may repeatedly determine a loss and adjust parameters. The loss may be determined based on a difference between an actual walking speed value and a walking speed estimation value output by the walking speed estimation model that receives sensor data. The parameters (e.g., a connection weight or a bias) of the model may be adjusted to reduce the loss. Through this training process, an optimal set of hyperparameters that define the structure of the walking speed estimation model may be identified.

According to an embodiment, the electronic device may detect successive heel strikes of a leg based on at least one of the sensor data generated by the angle sensor, the acceleration data generated by the IMU, or the angular velocity data generated by the IMU. The electronic device may calculate the time between detected heel strikes. The electronic device may calculate the step length based on the walking speed and the time between the heel strikes.

In operation 940, the electronic device may determine whether the position of the user's first leg corresponds to a target position based on the sensor data. The first leg may be either the user's left or right leg.

According to an embodiment, the target position may correspond to a position at which the first leg has a maximum and/or large angle in a forward direction. For example, based on the sensor data, the electronic device may determine the maximum angle of the first leg to be an angle just before the angle stops increasing and begins to decrease.

According to an embodiment, the target position may correspond to a position at which the heel of the first leg contacts the ground. The point at which the heel of the first leg contacts the ground may be the point at which the heel strike of the first leg occurs. For example, based on the sensor data, the electronic device may determine whether a heel strike of the first leg has occurred. When a heel strike of the first leg occurs, the position of the first leg may be determined to correspond to the target position.

When the position of the user's first leg is determined to correspond to the target position, operations 950 and 960 may be performed. When the position of the user's first leg is determined not to correspond to the target position, operations 970 and 980 may be performed.

In operation 950, the electronic device may determine a first position at which a first visual guide is to be output based on the gait information. For example, the first position may correspond to a position ahead by a first step length preset in the walking direction of the user from the landing position of the first leg.

According to an embodiment, the first position may be determined variously depending on the purpose. For example, the first position may correspond to a position ahead of the landing position of the first leg by an average step length of the user. For example, the first position may correspond to a position ahead of the landing position of the first leg by a target step length for the user.

According to an embodiment, the electronic device may determine the shape of the first visual guide to be output at the first position. For example, the electronic device may determine the shape of the first visual guide based on the user's current walking posture. For example, the electronic device may determine the shape of the first visual guide based on the user's target walking posture.

In operation 960, the electronic device may control the wearable device 100 so that the first visual guide is output at the first position. For example, the first optical output device 801 or the third optical output device 803 of the wearable device 100 may be controlled to output the first visual guide at the first position.

According to a walking phase of the user, after an event (e.g., a first event) in which the first leg is determined to correspond to the target position occurs, a new visual guide may not be output for the first leg until a next event (e.g., a second event) occurs. According to an embodiment, operations 970 and 980 may be performed until the second event occurs.

In operation 970, after the first visual guide is output at the first position, the electronic device may determine a first adjustment position at which the first visual guide is output based on the gait information. Since the user is walking, the first visual guide should move closer to the user until the second event occurs. For example, the first visual guide may move closer to the user at a speed corresponding to the walking speed in the gait information. The first adjustment position may be a position that moves closer to the user in real time from the first position. The first adjustment position may be repeatedly determined after the first event occurs and before the second event occurs.

In operation 980, the electronic device may control the wearable device 100 so that the first visual guide is output at the first adjustment position. For example, the first optical output device 801 or the third optical output device 803 of the wearable device 100 may be controlled so that the first visual guide is output at the first adjustment position.

According to an embodiment, although operations 940 to 980 describing the method of outputting the first visual guide for the user's first leg have been provided, the description of operations 940 to 980 may equally or similarly apply to the method of outputting the second visual guide for the user's second leg. For example, the second optical output device 802 or the fourth optical output device 804 of the wearable device 100 may be controlled to output the second visual guide for the second leg.

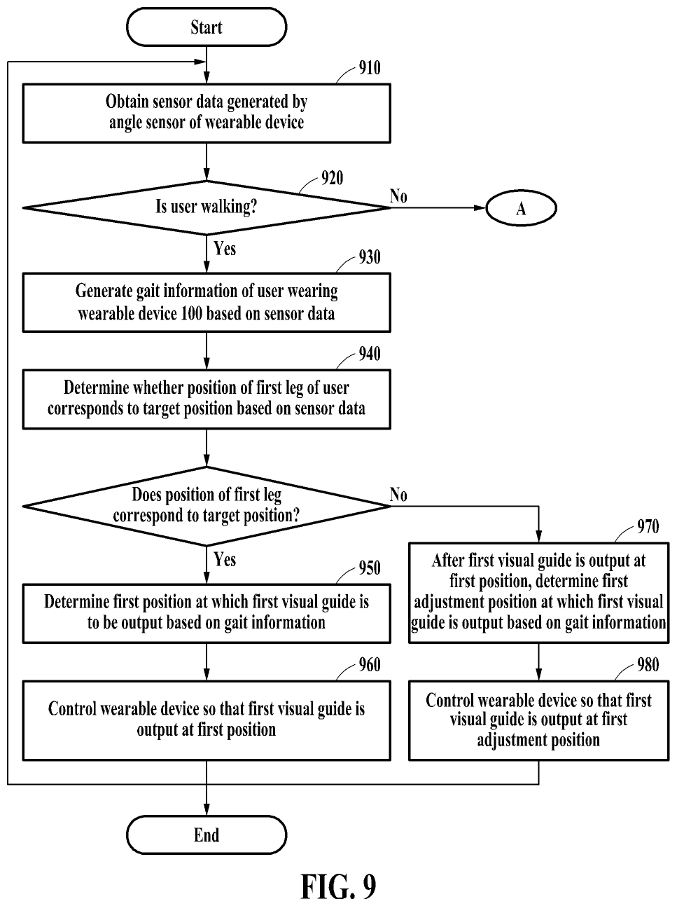

FIG. 10 illustrates a method of generating gait information based on sensor data generated during a user's walking, according to an embodiment.

According to an embodiment, the electronic device (e.g., the wearable device 100 of FIG. 1 or the electronic device 210 of FIG. 2) may calculate a height h between the driving module 120 and the ground as the gait information during the user's walking. For example, the height h may be a length between the center position of the driving module 120 and a position 1030. The position 1030 may be a point where the ground meets the center position of the driving module 120 in the direction of gravity. A step length a may be the distance between a position 1020 where a first leg (e.g., a left leg) contacts the ground and a position 1010 where a second leg (e.g., a right leg) contacts the ground. A first length a₁ may be defined by a height h and an angle R₁ as shown in Equation 1. A second length a₂ may be defined by a height h and an angle R₂ as shown in Equation 2.

$${a}_{1} = tan ( {R}_{1} ) \times h {a}_{2} = tan ( {R}_{2} ) \times h \qquad [ Equation 2 ]$$

The angle R₁ and the angle R₂ may be calculated based on sensor data. For example, when standing, the angle of a leg may be 0, when the leg moves backward, the angle may have a positive value, and when the leg moves forward, the angle may have a negative value. The setting of whether the angle is represented as a negative value or a positive value may be changed.

Since the step length a is the sum of the first length a₁ and the second length a₂, the height h may be calculated using Equation 3.

$$\begin{matrix}{a}_{1} + {a}_{2} = h \times ( tan ( {R}_{1} ) + tan ( {R}_{2} ) ) \\ a = h \times ( tan ( {R}_{1} ) + tan ( {R}_{2} ) ) \\ h = \frac{a}{tan ( {R}_{1} ) + tan ( {R}_{2} )}\end{matrix} \qquad [ Equation 3 ]$$

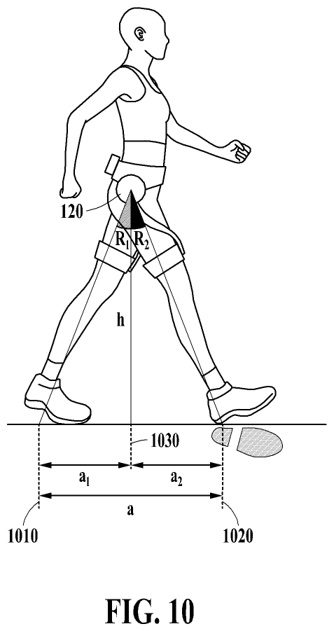

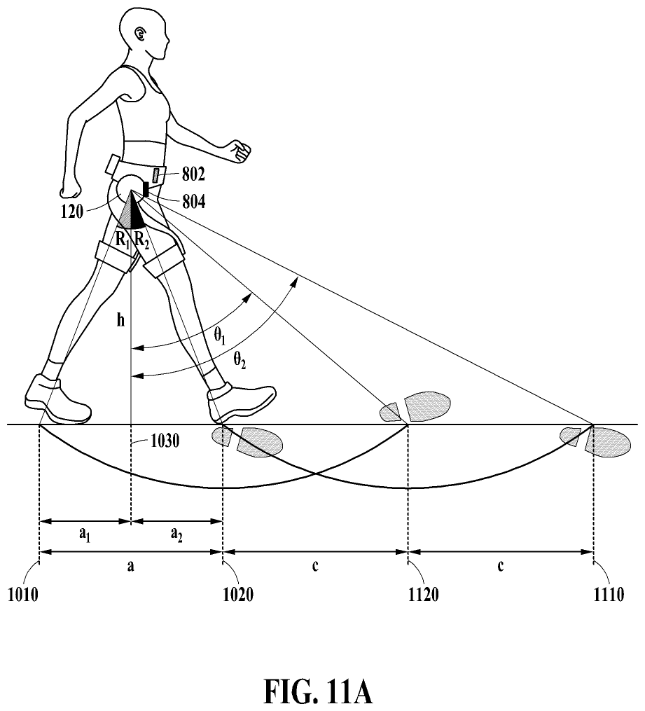

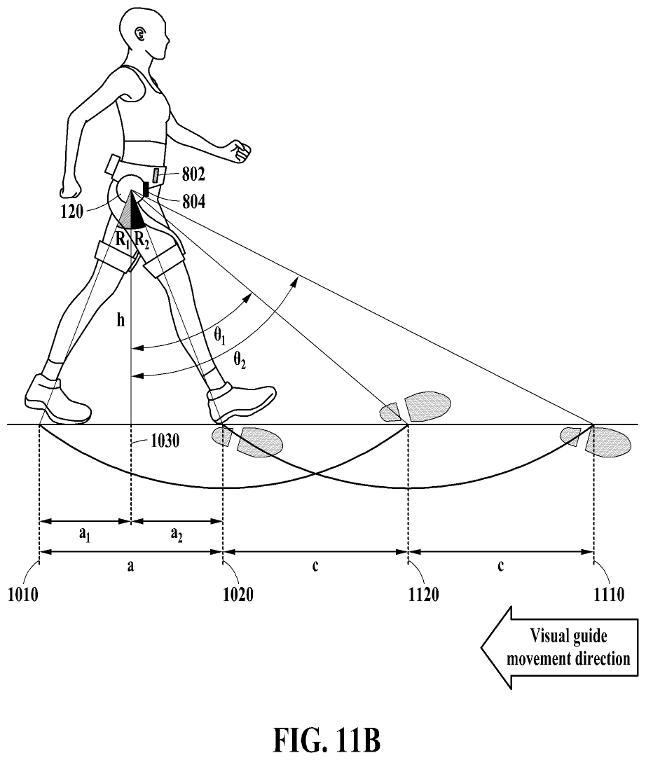

FIG. 11A illustrates a visual guide associated with a leg, according to an embodiment, and FIG. 11B illustrates a method of adjusting the position of an output visual guide, according to an embodiment.

According to an embodiment, an electronic device (e.g., the wearable device 100 of FIG. 1 or the electronic device 210 of FIG. 2) may determine a first position 1110 at which a first visual guide for a first leg is to be output when the first leg corresponds to a target position. The first position 1110 to be determined may not be an absolute position with respect to the ground but a relative position with respect to the wearable device 100. For example, the first position 1110 may be defined by a position and an orientation angle θ₂ of the driving module 120 (or the second light output device 802 or the fourth light output device 804). Since the position of the driving module 120 (or the second light output device 802 or the fourth light output device 804) does not change during walking, the electronic device may change the first position 1110 by adjusting the orientation angle θ₂. The electronic device may determine the orientation angle θ₂ to correspond to the sum of the second length a₂ and a preset length c×2. For example, the preset length c may be an average step length. For example, the preset length c may be a target step length. The orientation angle θ₂ may be calculated using Equation 4.

$${θ}_{2} = {tan}^{- 1} ( \frac{{a}_{2} + 2 c}{h} ) \qquad [ Equation 4 ]$$

According to an embodiment, the electronic device may determine a second correction position 1120, at which a second visual guide is output, based on the orientation angle θ₁. The second visual guide may be associated with the second leg, which is the left leg. As an event occurs for the second leg, an output position of the second visual guide may change in real time until the next event for the second leg occurs. For example, the output position of the second visual guide may change to move closer to the user's direction while corresponding to the user's walking speed. For example, when an event occurs for the first leg, the second correction position 1120 of the second visual guide may correspond to the sum of the step length a and the preset length c. The electronic device may determine the orientation angle θ₁ to correspond to the sum of the step length a and the preset length c.

Similar to the movement of the second visual guide described above, an output position of the first visual guide may change in real time until the next event for the first leg occurs. For example, the orientation angle θ₂ to be changed may be calculated using Equation 5 below.

$${θ}_{2} = {tan}^{- 1} ( \frac{{a}_{2} + 2 c - m}{h} ) \qquad [ Equation 5 ]$$

In Equation 5, m corresponds to the distance traveled according to the walking speed. While the user is walking, the positions at which the first guide and the second guide are output may change relative to the wearable device 100 but may not change relative to the ground.

FIG. 11C illustrates a method of adjusting an orientation angle of a light output device to output a visual guide based on an arrangement position of the light output device, according to an embodiment.

According to an embodiment, the orientation angle θ₂ calculated with reference to FIGS. 11A and 11B may be an orientation angle calculated based on the position of the driving module 120. For example, when a first visual guide 1143 is output by the third light output device 803, it may be output at a position 1141 instead of the position 1110 based on a difference P1 between the position of the driving module 120 and the position of the third light output device 803. The electronic device may calculate an orientation angle θ₃ by correcting the orientation angle θ₂ based on the difference P1 between the position of the driving module 120 and the position of the third light output device 803.

Similar to the description of the method of calculating the orientation angle θ₃ for outputting the first visual guide 1143, a method of calculating an orientation angle for outputting a second visual guide 1133 may be described. For example, when the second visual guide 1133 is output by the third light output device 803, it may be output at a position 1131 instead of the second correction position 1120 based on the difference P1 between the position of the driving module 120 and the position of the third light output device 803. The electronic device may calculate an orientation angle θ₄ by correcting the orientation angle θ₁ based on the difference P1 between the position of the driving module 120 and the position of the third light output device 803.

Although the method of outputting the first visual guide 1143 and the second visual guide 1133 by the fourth light output device 804 has been described, the above description may similarly apply when the output is performed by the second light output device 802 instead of the fourth light output device 804.

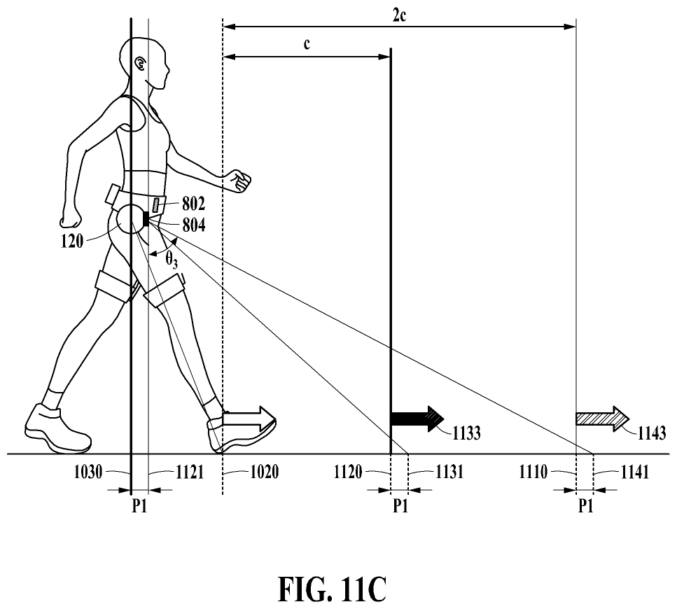

FIG. 12 illustrates visual guides output according to the progress of a walking cycle, according to an embodiment.

Phases 1211 to 1216 of the illustrated walking cycle may correspond to one step of a user. For example, assuming that one walking cycle is defined by a period from a heel strike of the user's right leg to the next heel strike of the right leg, the illustrated phases 1211 to 1216 may correspond to approximately 50% to 100% of the walking cycle.

When the user's left leg (e.g., a first leg) corresponds to the first phase 1211, a first visual guide 1220a may be output. For example, as the previous visual guide associated with the left leg, which was output in the phase prior to the first phase 1211, disappears, the first visual guide 1220a may be output. The previous visual guide may be output to correspond to the position of the ground stepped on by the left leg in the current walking cycle. At the first phase 1211, a second visual guide 1221a for the user's right leg (e.g., a second leg) may be output. The second visual guide 1221a may be output to correspond to the position of the ground stepped on by the right leg in the current walking cycle.

In phases 1212 to 1215, the first visual guide 1220a and the second visual guide 1221a may not change relative to the position of the ground. As the user moves, the positions of the wearable device 100 and the first and second visual guides 1220a and 1221a on the ground gradually approach each other, and one or more light output devices of the wearable device 100 may be controlled so that the first and second visual guides 1220a and 1221a do not change relative to the position of the ground. For example, orientation angles of one or more light output devices may be gradually controlled to face toward the ground.

At the sixth phase 1216, when the user's right leg corresponds to a target position, a third visual guide 1221b may be output. For example, as the second visual guide 1221a associated with the right leg, which was output in the phase prior to the sixth phase 1216, disappears, the third visual guide 1221b may be output. The third visual guide 1221b may be output to correspond to the position of the ground stepped on by the right leg in the next walking cycle.

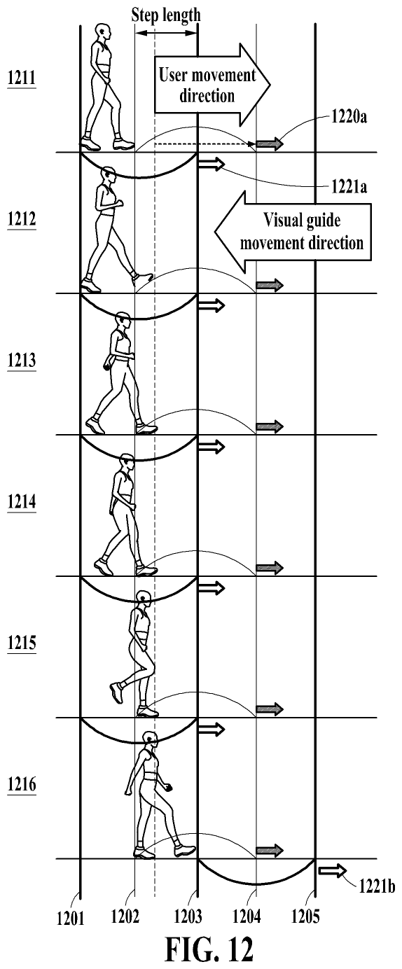

FIG. 13 illustrates a plurality of visual guides output to correspond to a plurality of predicted landing positions of a leg, according to an embodiment.

According to an embodiment, the wearable device 100 may simultaneously output a plurality of visual guides 1301, 1302, 1303, and 1304 using one or more light output devices (e.g., the light output devices 801, 802, 803, and 804 in FIG. 8A).

According to an embodiment, the second light output device 802 may include a plurality of lenses and simultaneously output the first visual guide 1301 and the second visual guide 1302 using the plurality of lenses. The first light output device 801 may include a plurality of lenses and simultaneously output the third visual guide 1303 and the fourth visual guide 1304 using the plurality of lenses.

According to an embodiment, the second light output device 802 may output the first visual guide 1301, and the fourth light output device 804 may output the second visual guide 1302. The first light output device 801 may output the third visual guide 1303, and the third light output device 803 may output the fourth visual guide 1304.

For example, an output position of the first visual guide 1301 may be a first position predicted (or targeted) as a landing position of the user's right leg (e.g., a first leg), and an output position of the second visual guide 1302 may be a second position predicted as the next landing position of the right leg. That is, the first position may correspond to a first landing position of the right leg, and the second position may correspond to a second landing position of the right leg. The first position and the second position may be determined based on an average step length or a current step length of the user.

For example, an output position of the third visual guide 1303 may be a third position predicted (or targeted) as a landing position of the user's left leg (e.g., a second leg), and an output position of the fourth visual guide 1304 may be a fourth position predicted as the next landing position of the left leg. That is, the third position may correspond to a first landing position of the left leg, and the fourth position may correspond to a second landing position of the left leg.

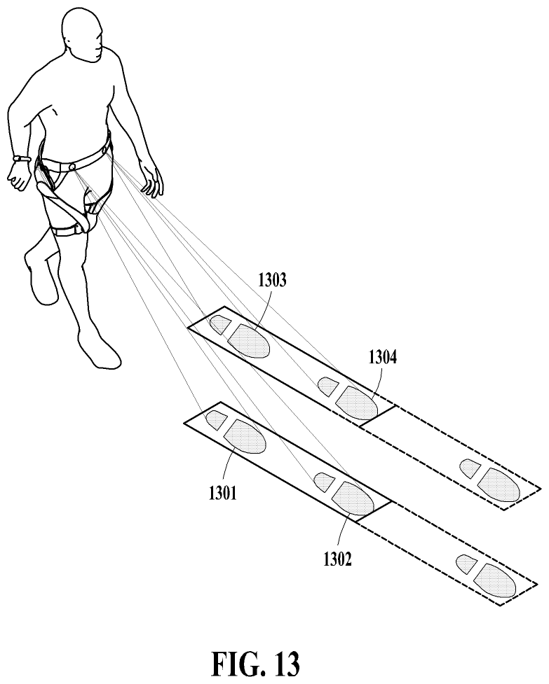

FIG. 14 illustrates a plurality of visual guides output to correspond to a predicted landing position and a target landing position of a leg, according to an embodiment.

According to an embodiment, the wearable device 100 may simultaneously output a plurality of visual guides 1401, 1402, 1404, and 1405 using one or more light output devices (e.g., the light output devices 801, 802, 803, and 804 in FIG. 8A).

According to an embodiment, the second light output device 802 may include a plurality of lenses and simultaneously output the first visual guide 1401 and the second visual guide 1402 using the plurality of lenses. The first light output device 801 may include a plurality of lenses and simultaneously output the third visual guide 1404 and the fourth visual guide 1405 using the plurality of lenses.

According to an embodiment, the second light output device 802 may output the first visual guide 1401, and the fourth light output device 804 may output the second visual guide 1402. The first light output device 801 may output the third visual guide 1404, and the third light output device 803 may output the fourth visual guide 1405.

For example, an output position of the first visual guide 1401 may be a first position predicted as a landing position of the user's right leg (e.g., a first leg), and an output position of the second visual guide 1402 may be a second position targeted as a landing position of the right leg. The first position may correspond to a position ahead by an average step length from the landing position of the right leg in the walking direction of the user, and the second position may correspond to a position ahead by a target step length from the landing position of the right leg in the walking direction of the user. For example, the target step length may be a step length proposed to the user to improve the user's walking habits.

For example, an output position of the third visual guide 1404 may be a third position predicted as a landing position of the user's left leg (e.g., a second leg), and an output position of the fourth visual guide 1405 may be a fourth position targeted as a landing position of the left leg. The third position may correspond to a position ahead by an average step length from the landing position of the left leg in the walking direction of the user, and the fourth position may correspond to a position ahead by a target step length from the landing position of the left leg in the walking direction of the user.

According to an embodiment, the second light output device 802 or the fourth light output device 804 may output a first additional visual guide 1403. For example, the first additional visual guide 1403 may indicate a target step length (or a corrected step length).

According to an embodiment, the first light output device 801 or the third light output device 803 may output a second additional visual guide 1406. For example, the second additional visual guide 1406 may represent an average step length (or a current step length).

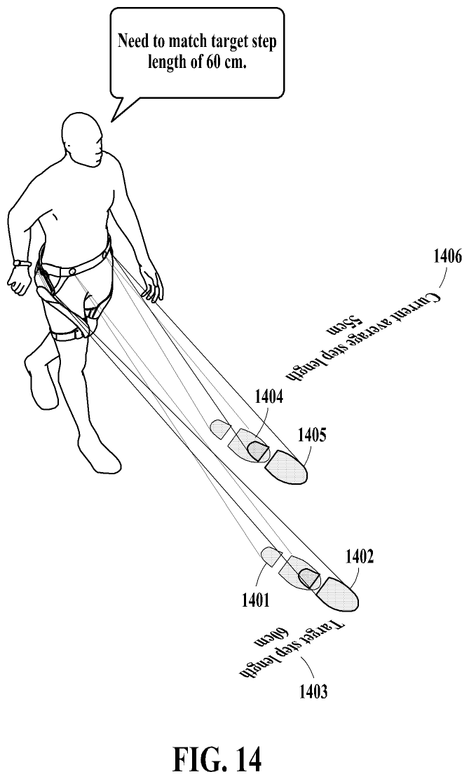

FIG. 15 illustrates a plurality of visual guides output to improve gait symmetry, according to an embodiment.

According to an embodiment, the wearable device 100 may simultaneously output a plurality of visual guides 1501, 1502, and 1503 using one or more light output devices (e.g., the light output devices 801, 802, 803, and 804 in FIG. 8A).

According to an embodiment, the second light output device 802 may include a plurality of lenses and simultaneously output the first visual guide 1501 and additional visual guides 1504 and 1505 using the plurality of lenses. The first light output device 801 may include a plurality of lenses and simultaneously output the second visual guide 1502 and the third visual guide 1503 using the plurality of lenses.

According to an embodiment, the second light output device 802 may output the first visual guide 1501, the first light output device 801 may output the second visual guide 1502, and the third light output device 803 may output the third visual guide 1503.

For example, an output position of the first visual guide 1501 may be a first position predicted as a landing position of the user's right leg (e.g., a first leg), an output position of the second visual guide 1502 may be a second position predicted as a landing position of the user's left leg (e.g., a second leg), and an output position of the third visual guide 1503 may be a third position targeted as a landing position of the left leg. For example, the third position may be a position ahead of the second position. For example, the electronic device may determine the user's gait symmetry based on at least one of sensor data generated by an angle sensor (e.g., the angle sensor 125 of FIG. 1 or the first angle sensor 524 or the second angle sensor 524-1 of FIG. 5B), acceleration data, and angular velocity data generated by an IMU (e.g., the IMU 135 of FIG. 1 or the IMU 522 of FIG. 5B) of the wearable device 100. The electronic device may determine the third position based on the user's gait symmetry.

For example, the additional visual guide 1504 may indicate the reason for outputting the third visual guide 1503. For example, the additional visual guide 1505 may indicate a difference between the second visual guide 1502 and the third visual guide 1503.

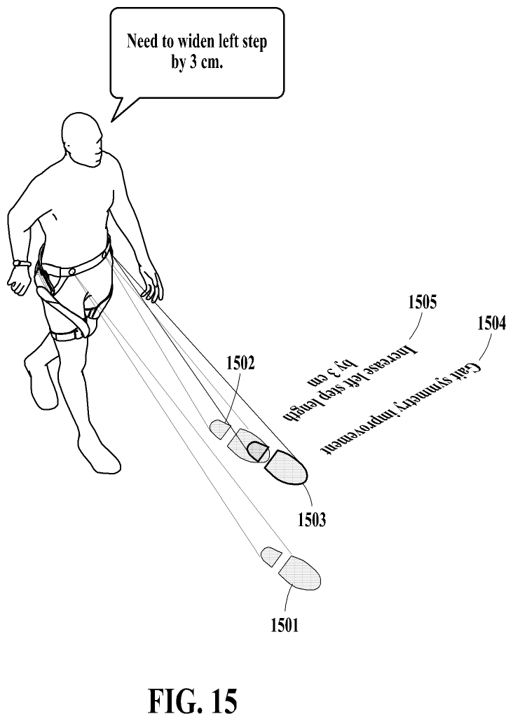

FIG. 16 illustrates a numeric count output in association with a visual guide, according to an embodiment.

According to an embodiment, the wearable device 100 may simultaneously output a plurality of visual guides 1601 and 1603 using one or more light output devices (e.g., the light output devices 801, 802, 803, and 804 in FIG. 8A). In addition, the wearable device 100 may further output a numeric count 1602 as an additional visual guide. An electronic device (e.g., the wearable device 100 of FIG. 1 or the electronic device 210 of FIG. 2) may predict a time at which the user's right leg (e.g., a first leg) steps on a position corresponding to the first visual guide 1601 based on gait information and output the numeric count 1602 corresponding to the predicted time.

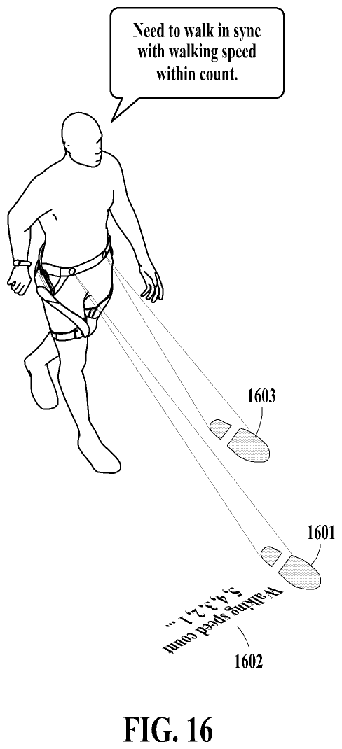

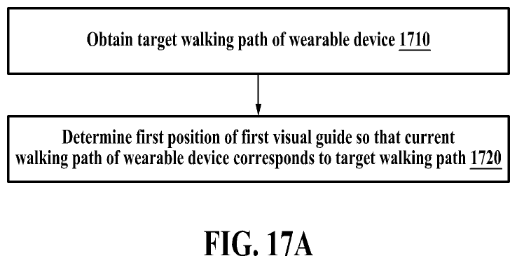

FIG. 17A is a flowchart illustrating a method of determining a position of a visual guide based on a target walking path according to an embodiment, and FIG. 17B illustrates visual guides output based on the target walking path according to an embodiment.

In the following embodiments, operations may be performed sequentially but may not be necessarily performed sequentially. For example, the order of the operations may be changed and at least two of the operations may be performed in parallel.

According to an embodiment, operations 1710 and 1720 described below may be performed by an electronic device (e.g., the wearable device 100 of FIG. 1 or the electronic device 210 of FIG. 2). For example, operation 1710 may be performed prior to the performance of operation 910 described above with reference to FIG. 9. Operation 1720 may be associated with operation 950 described above with reference to FIG. 9. For example, operation 950 may include operation 1720.

In operation 1710, the electronic device may obtain a target walking path 1740 of the wearable device 100. For example, the electronic device may obtain (or generate) the target walking path 1740 based on a destination set by a user on a map and a current position.

In operation 1720, the electronic device may determine a first position 1751 or 1761 of a first visual guide so that a current walking path 1750 or 1760 of the wearable device 100 corresponds to the target walking path 1740.

According to an embodiment, the electronic device may determine a previous walking path walked by the user based on sensor data. According to an embodiment, the electronic device may determine the previous walking path walked by the user based on global positioning system (GPS) information. Based on the previous walking path, the electronic device may determine the first position 1751 or 1761 of the first visual guide so that the current walking path 1750 or 1760 corresponds to the target walking path 1740.

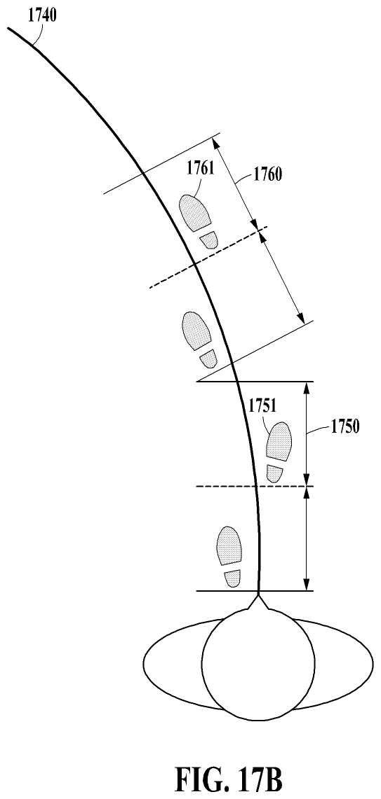

FIG. 18 illustrates a first visual guide output with a shape determined based on a current walking posture of a leg and a second visual guide output with a shape determined based on a target walking posture, according to an embodiment.

According to an embodiment, the wearable device 100 may simultaneously output a plurality of visual guides 1801, 1802, 1804, and 1805 using one or more light output devices (e.g., the light output devices 801, 802, 803, and 804 in FIG. 8A).

According to an embodiment, the second light output device 802 may include a plurality of lenses and simultaneously output the first visual guide 1801 and the second visual guide 1802 using the plurality of lenses. The first light output device 801 may include a plurality of lenses and simultaneously output the third visual guide 1804 and the fourth visual guide 1805 using the plurality of lenses.

According to an embodiment, the second light output device 802 may output the first visual guide 1801, and the fourth light output device 804 may output the second visual guide 1802. The first light output device 801 may output the third visual guide 1804, and the third light output device 803 may output the fourth visual guide 1805.

An output position of the first visual guide 1801 may be a first position predicted as a landing position of the user's right leg (e.g., a first leg), and an output position of the second visual guide 1802 may be a second position predicted as a landing position of the right leg.

The first visual guide 1801 output at the first position may have a shape determined based on the user's current walking posture. For example, the electronic device may determine the user's current walking posture based on at least one of sensor data generated by an angle sensor (e.g., the angle sensor 125 of FIG. 1 or the first angle sensor 524 or the second angle sensor 524-1 of FIG. 5B), acceleration data, and angular velocity data generated by an IMU (e.g., the IMU 135 of FIG. 1 or the IMU 522 of FIG. 5B) of the wearable device 100. For example, the walking posture may include the orientation of the sole of the foot during walking. For example, the walking posture may include a toe-out walking posture or a toe-in walking posture.

The second visual guide 1802 output at the second position may have a shape determined based on the user's target walking posture. For example, the target walking posture may be a normal walking posture.

According to an embodiment, the second light output device 802 or the fourth light output device 804 may output a first additional visual guide 1803. For example, the first additional visual guide 1803 may indicate a target walking posture (or a corrected walking posture).

According to an embodiment, the first light output device 801 or the third light output device 803 may output a second additional visual guide 1806. For example, the second additional visual guide 1806 may represent a current walking posture.

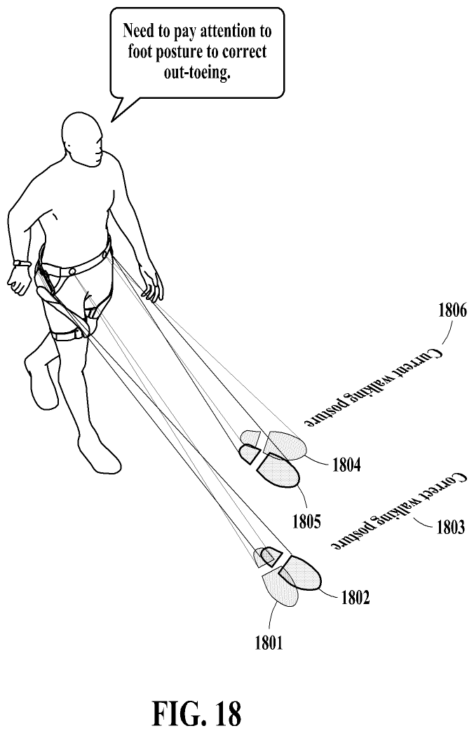

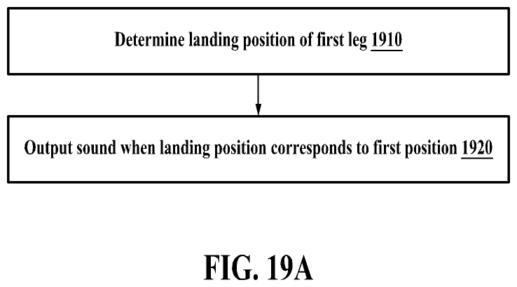

FIG. 19A is a flowchart illustrating a method of outputting sound based on a landing position of a leg according to an embodiment, and FIG. 19B illustrates a method of outputting sound based on a landing position of the leg according to an embodiment.

In the following embodiments, operations may be performed sequentially but may not be necessarily performed sequentially. For example, the order of the operations may be changed and at least two of the operations may be performed in parallel.

According to an embodiment, operations 1910 and 1920 described below may be performed by an electronic device (e.g., the wearable device 100 of FIG. 1 or the electronic device 210 of FIG. 2). For example, operations 1910 and 1920 may be performed after the performance of operation 910 described above with reference to FIG. 9.

In operation 1910, the electronic device may determine a landing position of a first leg. The determined landing position may be an actual landing position in a current step rather than an expected landing position in the next step. For example, the landing position of the first leg may be a position corresponding to a step length and a direction calculated for the current step based on a landing position in the previous step.

In operation 1920, the electronic device may output sound when the determined landing position of the first leg corresponds to a first position. For example, the first position may be an expected landing position of the first leg predicted during the previous step. An output sound may be set by a user. For example, a first sound may be output when the landing position of a left leg corresponds to a first position 1902, and a second sound may be output when the landing position of a right leg corresponds to a second position 1901.

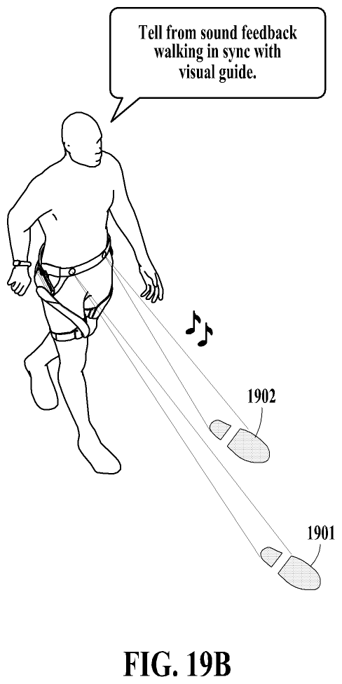

FIG. 20 is a flowchart illustrating a method of outputting a visual guide based on a user's gaze direction, according to an embodiment.

In the following embodiments, operations may be performed sequentially but may not be necessarily performed sequentially. For example, the order of the operations may be changed and at least two of the operations may be performed in parallel.

According to an embodiment, operations 2010 and 2020 described below may be performed by an electronic device (e.g., the wearable device 100 of FIG. 1 or the electronic device 210 of FIG. 2). For example, operations 2010 and 2020 may be performed in parallel to and independently of operations 910 to 960 described above with reference to FIG. 9.

In operation 2010, the electronic device may determine the gaze direction of the user. For example, the electronic device may determine the gaze direction of the user based on at least one of acceleration data and angular velocity data generated by an IMU (e.g., the IMU 135 of FIG. 1 or the IMU 522 of FIG. 5B). For example, the electronic device may receive at least one of acceleration data and angular velocity data generated by an IMU of the other wearable device 220 (e.g., the smart glasses 226) and determine the gaze direction of the user based on the received data.

In operation 2020, the electronic device may control a wearable device so that a first visual guide is not output when the gaze direction does not correspond to a preset direction. For example, while the first visual guide is being output, if the gaze direction of the user is determined to be not directed toward the ground, the output of the first visual guide may be interrupted.

Conversely, while the first visual guide is not being output, if the user's gaze direction is determined to be directed toward the ground, the output of the first visual guide may be resumed.

FIG. 21 is a flowchart illustrating a method of outputting a visual guide when a user is not walking, according to an embodiment, and FIG. 22 illustrates a visual guide output when the user is not walking, according to an embodiment.

In the following embodiments, operations may be performed sequentially but may not be necessarily performed sequentially. For example, the order of the operations may be changed and at least two of the operations may be performed in parallel.

According to an embodiment, operations 2110 to 2130 described below may be performed by an electronic device (e.g., the wearable device 100 of FIG. 1 or the electronic device 210 of FIG. 2). For example, operations 2110 to 2130 may be performed when the user wearing the wearable device 100 is determined not to be walking in operation 920 described above with reference to FIG. 9.

In operation 2110, the electronic device may determine the position (e.g., a current position) of a first leg. For example, the positions of the first leg and a second leg may be determined based on sensor data generated by an angle sensor (e.g., the angle sensor 125 of FIG. 1 or the first angle sensor 524 or the second angle sensor 524-1 of FIG. 5B).

In operation 2120, the electronic device may determine a first position at which a first visual guide is to be output based on initial gait information. For example, the initial gait information may be the most recently stored average gait information of the user. The first position may correspond to a position on which the first leg steps next when the user is walking.

According to an embodiment, when the first leg is positioned behind the second leg, the first position of the first visual guide for the first leg may be determined to be closer to the user than the second position of the second visual guide for the second leg.

According to an embodiment, the first position of the first visual guide for the first leg and the second position of the second visual guide for the second leg may be determined based on the user's walking habits. For example, when the user starts walking with the first leg, the first position of the first visual guide for the first leg may be determined to be closer to the user than the second position of the second visual guide for the second leg.

After the user starts walking, operations 930 to 980 described above with reference to FIG. 9 may be performed.

According to an embodiment, an electronic device 100; 210 may include at least one processor 512; 710 including processing circuitry and memory 514; 720 including one or more storage media storing instructions, in which the instructions, when executed individually or collectively by the at least one processor 512; 710, cause the electronic device 100; 210 to: obtain sensor data generated by an angle sensor 125; 524; 524-1 of a wearable device 100, generate gait information of a user 110 wearing the wearable device 100 based on the sensor data, determine whether a position of a first leg of the user 110 corresponds to a target position based on the sensor data, and when the position of the first leg corresponds to the target position, control the wearable device 100 so that a first visual guide associated with the first leg is output at a first position based on the gait information.

According to an embodiment, the gait information may include at least one of a step length and a walking speed of the user 110.

According to an embodiment, the instructions, when executed individually or collectively by the at least one processor 512; 710, cause the electronic device 100; 210 to: determine the walking speed of the user 110 by employing a walking speed estimation model with the sensor data as input.

According to an embodiment, the instructions, when executed individually or collectively by the at least one processor 512; 710, cause the electronic device 100; 210 to: input, to the walking speed estimation model, acceleration data and angular velocity data generated by an IMU 135; 522 of the wearable device 100 and the sensor data generated by the angle sensor 125; 524; 524-1, and output the walking speed based on the acceleration data, the angular velocity data, and the sensor data input to the walking speed estimation model.

According to an embodiment, the target position may correspond to a position at which the first leg has a maximum angle in a forward direction.

According to an embodiment, the first position may correspond to a position ahead by a preset first step length from a landing position of the first leg in the walking direction of the user 110.

According to an embodiment, the instructions, when executed individually or collectively by the at least one processor 512; 710, cause the electronic device 100; 210 to: after the first visual guide has been output at the first position, determine, based on the gait information, a first adjustment position at which the first visual guide is to be output, and control the wearable device 100 so that the first visual guide is output at the first adjustment position.

According to an embodiment, the instructions, when executed individually or collectively by the at least one processor 512; 710, cause the electronic device 100; 210 to: when the position of the first leg corresponds to the target position, control the wearable device 100 based on the gait information so that a second visual guide associated with the first leg is output at a second position.

According to an embodiment, the first position may correspond to a first landing position of the first leg, and the second position may correspond to a second landing position of the first leg.

According to an embodiment, the first position may correspond to a position ahead by an average step length from the landing position of the first leg in the walking direction of the user 110, and the second position may correspond to a position ahead by a target step length from the landing position of the first leg in the walking direction of the user 110.

According to an embodiment, the first visual guide output at the first position may have a shape determined based on a current walking posture of the user 110, and the second visual guide output at the second position may have a shape determined based on a target walking posture of the user 110.

According to an embodiment, the instructions, when executed individually or collectively by the at least one processor 512; 710, cause the electronic device 100; 210 to: while the first visual guide is output, control the wearable device 100 to output, in association with the first visual guide, a gradually decreasing numeric count.

According to an embodiment, the instructions, when executed individually or collectively by the at least one processor 512; 710, cause the electronic device 100; 210 to: obtain a target walking path of the wearable device 100, and determine the first position of the first visual guide so that a current walking path of the wearable device 100 corresponds to the target walking path.

According to an embodiment, the instructions, when executed individually or collectively by the at least one processor 512; 710, cause the electronic device 100; 210 to: determine the landing position of the first leg, and when the landing position corresponds to the first position, output a sound.

According to an embodiment, the instructions, when executed individually or collectively by the at least one processor 512; 710, cause the electronic device 100; 210 to: determine a gaze direction of the user 110, and when the gaze direction does not correspond to a preset direction, control the wearable device 100 so that the first visual guide is not output.

According to an embodiment, the electronic device 100; 210 may be included in the wearable device 100.

According to an embodiment, a method, performed by an electronic device 100; 210, of controlling a wearable device 100 may include operation 910 of obtaining sensor data generated by an angle sensor 125; 524; 524-1 of the wearable device 100; operation 930 of generating gait information of a user 110 wearing the wearable device 100 based on the sensor data; operation 940 of determining whether a position of a first leg of the user 110 corresponds to a target position based on the sensor data; and operation 970 of, when the position of the first leg corresponds to the target position, controlling the wearable device 100 so that a first visual guide associated with the first leg is output at a first position based on the gait information. “Based on” as used herein covers based at least on.

According to an embodiment, a wearable device 100 may include a base body 80 positioned at a waist part of a user 110 when the wearable device 100 is worn on a body of the user 110; a waist support frame 20 and a leg support frame 50; 55 configured to support at least a portion of the body of the user 110; a thigh fastener 1; 2 configured to fix the leg support frame 50; 55 to a thigh of the user 110; an IMU 135 provided inside the base body 80; a driving module 35; 45; 120; 530 generating torque applied to a leg of the user 110, wherein the driving module 35; 45; 120; 530 is positioned between the waist support frame 20 and the leg support frame 50; 55 and the driving module 35; 45; 120; 530 may include a motor 534 and a motor driver circuit 532; one or more optical output devices outputting a visual guide on the ground; at least one processor 512 including processing circuitry; and memory 514 including one or more storage media storing instructions.

According to an embodiment, a first optical output device among the one or more optical output devices may be mounted on, directly or indirectly, the driving module 35; 45; 120; 530 to output a first visual guide in front of the user 110 when the wearable device 100 is worn on a body of the user 110.

The example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts.

Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other example embodiments, and equivalents to the claims are also within the scope of the following claims.

1. An electronic device comprising:
at least one processor comprising processing circuitry; and
memory comprising one or more storage media storing instructions,
wherein the instructions, when executed individually and/or collectively by the at least one processor, cause the electronic device to:
acquire sensor data generated by an angle sensor of a wearable device, generate gait information of a user wearing the wearable device based on the sensor data,
determine whether a position of a first leg of the user corresponds to a target position based on the sensor data, and
when the position of the first leg corresponds to the target position, control the wearable device so that a first visual guide associated with the first leg is output at a first position based on the gait information.

2. The electronic device of claim 1, wherein
the gait information comprises at least one of a step length and/or a walking speed of the user.

3. The electronic device of claim 2, wherein
the instructions, when executed individually and/or collectively by the at least one processor, cause the electronic device to:
determine the walking speed of the user at least by employing a walking speed estimation model with the sensor data as input.

4. The electronic device of claim 3, wherein
the instructions, when executed individually and/or collectively by the at least one processor, cause the electronic device to:
input, to the walking speed estimation model, acceleration data and angular velocity data generated by an inertial measurement unit (IMU) of the wearable device and the sensor data generated by the angle sensor, and
output the walking speed based on the acceleration data, the angular velocity data, and the sensor data input to the walking speed estimation model.

5. The electronic device of claim 1, wherein
the target position corresponds to a position where the first leg has a maximum and/or large angle in a forward direction.

6. The electronic device of claim 1, wherein
the first position corresponds to a position ahead by a preset first step length from a landing position of the first leg in the walking direction of the user.

7. The electronic device of claim 1, wherein
the instructions, when executed individually and/or collectively by the at least one processor, cause the electronic device to:
after the first visual guide has been output at the first position, determine, based on the gait information, a first adjustment position at which the first visual guide is to be output, and
control the wearable device so that the first visual guide is output at the first adjustment position.

8. The electronic device of claim 1, wherein
the instructions, when executed individually and/or collectively by the at least one processor, cause the electronic device to:
when the position of the first leg corresponds to the target position, control the wearable device based on the gait information so that a second visual guide associated with the first leg is output at a second position.

9. The electronic device of claim 8, wherein
the first position corresponds to a first landing position of the first leg, and
the second position corresponds to a second landing position of the first leg.

10. The electronic device of claim 8, wherein
the first position corresponds to a position ahead by an average step length from the landing position of the first leg in the walking direction of the user, and
the second position corresponds to a position ahead by a target step length from the landing position of the first leg in the walking direction of the user.

11. The electronic device of claim 8, wherein
the first visual guide output at the first position has a shape based on a current walking posture of the user, and
the second visual guide output at the second position has a shape based on a target walking posture of the user.

12. The electronic device of claim 1, wherein
the instructions, when executed individually and/or collectively by the at least one processor, cause the electronic device to:
while the first visual guide is output, control the wearable device to output, in association with the first visual guide, a gradually decreasing numeric count.

13. The electronic device of claim 1, wherein
the instructions, when executed individually and/or collectively by the at least one processor, cause the electronic device to:
acquire a target walking path of the wearable device, and
determine the first position of the first visual guide so that a current walking path of the wearable device corresponds to the target walking path.

14. The electronic device of claim 1, wherein
the instructions, when executed individually and/or collectively by the at least one processor, cause the electronic device to:
determine the landing position of the first leg, and
when the landing position corresponds to the first position, output a sound.

15. The electronic device of claim 1, wherein
the instructions, when executed individually and/or collectively by the at least one processor, cause the electronic device to:
determine a gaze direction of the user, and
when the gaze direction does not correspond to a preset direction, control the wearable device so that the first visual guide is not output.

16. The electronic device of claim 1, wherein
the electronic device is included in the wearable device.

17. A method, performed by an electronic device, of controlling a wearable device, the method comprising:
acquiring sensor data generated by a sensor of the wearable device;
generating gait information of a user wearing the wearable device based on the sensor data;
determining whether a position of a first leg of the user corresponds to a target position based on the sensor data; and
when the position of the first leg corresponds to the target position, controlling the wearable device so that a first visual guide associated with the first leg is output at a first position based on the gait information.

18. A computer-readable storage medium storing a computer program that, when executed by a processor, causes the processor to perform the method of claim 17.

19. A wearable device comprising:
a base body configured to be positioned proximate a waist part of a user when the wearable device is worn on a body of the user;
a waist support frame and a leg support frame configured to support at least a portion of the body of the user;
a thigh fastener configured to attach the leg support frame to a thigh of the user;
an inertial measurement unit (IMU), comprising a sensor, disposed in the base body;
a driving module, comprising a motor and/or circuitry, configured to generate torque to be applied to a leg of the user, wherein the driving module is configured to be positioned between the waist support frame and the leg support frame;
one or more optical output devices configured for outputting a visual guide on the ground;
at least one processor comprising processing circuitry; and
memory comprising one or more storage media storing instructions.

20. The wearable device of claim 19, wherein
a first optical output device among the one or more optical output devices is provided on the driving module and configured to output a first visual guide in front of the user when the wearable device is worn on a body of the user.
